(19) United States
(12) Patent Application Publication
(10) Pub. No.: US 2011/0081471 A1
(43) Pub. Date: Apr. 7, 2011

(54) Cooking Apparatus

(76) Inventors: Don McLemore, Fortson, GA (US); John D. McLemore, Forston, GA (US); Adam Carter, Auburn, AL (US); James R. Carden, Columbus, GA (US)

(21) Appl. No.: 12/571,492

(22) Filed: Oct. 1, 2009

(51) Int. Cl. A23L 1/00; A47J 37/12; B65D 51/04; F27D 11/00; B65D 25/28

(52) U.S. Cl. 426/523; 99/410; 220/826; 219/438; 220/752

(57) ABSTRACT

A cooking apparatus which includes a shell assembly having a cover assembly that has two cover parts that are pivotally connected to each other with one of the two pivotally connected to a shell body of the cooking apparatus such that the cover parts can be adjusted from a cooking pot cover position to a cooking pot access position where the cover parts are collapsed with opposing pot cover faces arranged in an over center location. The shell body includes a recessed section which is filled in with a heating device support structure as in a corner filling support structure that is frictionally mounted on a common base as that of the shell. A rectangular shaped cooking apparatus includes a corner filled in with the heating support tower and a spigot access cover at another corner along a common side as the support structure. Also a house shaped cooking pot with tapered side walls provide for cooking a whole turkey of 12 pounds or more with 2 gallons or less and also has its roof shaped wall region extending between the spigot access and heating device support structure locations. The cover includes an apertured, cantilever hand grip extension that extends over the heater support structure.

### FIELD OF THE INVENTION EXAMPLE(S)

The present invention includes a cooking apparatus with an embodiment having a domestic indoor-type electric power sourced fryer that is well suited for deep frying in oil large food objects such as a whole turkey, while also being suited for cooking other food types (with the same type or different type of cooking fluid as in water).

### BACKGROUND OF THE INVENTION

Outdoor deep frying of, for example, whole turkeys has gained in popularity with the advent of outdoor cooking apparatus such as the “Grand Slam Turkey Fryer”™ of Masterbuilt Mfg. Inc. in Columbus, Ga., USA which includes an outdoor propane burner, large cooking pot (e.g., 30 quarts [or 28.4 liters]), a cooking basket (as a means for manipulating large food items as in a whole turkey) and a grab handle. A cooking apparatus of this type provides for deep frying large food items with turkeys (e.g., 8 to 18 lbs [3.6 Kg to 8.2 Kg] in weight) being illustrative. However, weather conditions or the lack of a suitable location (e.g., apartment dwellers) can prevent or lessen the desire to use an outdoor cooking apparatus.

Additional prior art outdoor cooking apparatus include seafood steam cookers as well as deep fry steak cookers as illustrated by Masterbuilt's “Sizzlin Steak Rack”™ (U.S. Pat. No. 6,742,446) which is incorporated by reference. There is also featured in the prior art a cooking apparatus featuring a drain spigot and hanging basket arrangement as seen from Masterbuilt's U.S. Pat. No. 6,711,992, which is incorporated by reference.

As illustrated by U.S. Pat. Nos. 2,032,175; 2,597,695; 2,785,277 there also exist indoor, home use or domestic electric fryers which are principally designed for frying small, multiple individual food items in groups as in fries, onion rings, and vegetables.

With large volume food inserts such as a 14 lb [6.4 Kg] whole turkey or similarly sized food item (e.g., 14±3 lb [6.4 Kg±1.4 Kg], in the prior art systems there is required a relatively large volume of cooking fluid for suitable coverage of the inserted food (e.g., the above noted 30 quart [28.4 liter] outdoor cooking pot). However, there is associated with large volume outdoor cooking apparatus a corresponding long cooking fluid heat up time (and cooling) as well as consumption of a large volume of the cooking fluid.

Examples of domestic indoor type electric power sourced fryers that are suitable for food items such as the above described large turkeys are seen in U.S. Pat. Nos. 6,941,857 and 7,412,922 as well as US Publication No. 2009/0087534 each having inventors John and Don McLemore. Commercial models of electric turkey fryers, such as those described in these patent and publications, are available from the above noted Masterbuilt Mfg. Inc.

### SUMMARY OF EXAMPLES OF INVENTIVE SUBJECT MATTER

Invention embodiments include a cooking apparatus that is preferably an indoor (e.g., indoor being in the sense of indoor type as in non-outdoor or limited (temporary and controlled) outdoor use (e.g., limited open deck usage) as in one with an electric power sourced cooker (e.g., fryer)). Embodiments include a non-commercial or domestic “house use” sized electric fryer that yet can accommodate large single piece food items such as a “whole” turkey (e.g., 8 to 18 lb [3.63 Kg to 8.16 Kg] or a whole turkey in the more common 10 or 11 or 12 to 14 lb [4.54 Kg to 6.35 Kg] range). Also, in an embodiment, while being able to handle items such as an 8 to 18 lb [3.63 Kg to 8.16 Kg] turkey, there is maintained relatively low volume usage of cooking fluid (e.g., 4 to 12 quarts—or 1 gallon to 3 gallons) in a first embodiment and 6 to 10 quarts (1.5 to 2.5 gallons) in even further reduced cooking fluid volume alternate embodiments with an about 8 quart (or about 2 gallon) “fill line” demarcation being an example. A one gallon minimum fill line is a well suited level for cooking non-whole turkey food items (e.g., turkey breasts or steaks or cornish hens) while a 2 gallon level is well suited for use with frying a whole turkey of about 14 lbs. A 2 gallon whole turkey recommended fill line represents about a 33% percent reduction in an example of a pre-designated cooking fluid amount (e.g., to a preferred preset fill line) featured in the above described U.S. Pat. No. 7,412,922 as well as US Publication No. 2009/0087534 to Don and John McLemore. An embodiment of the present invention thus provides a means for domestic home owners to enjoy deep fried large food items such as a whole turkey in an electric fryer positioned on a countertop, tabletop, garage situated support, deck support (e.g., limited environmental use on an open deck such as in one with an electrical outlet) or the like with efficient low cooking fluid volume usage.

An embodiment features a cooking apparatus comprising a cooking pot and a shell assembly having a shell main body with a reception cavity for receiving the cooking pot. Further provided is a heating assembly (e.g., a controllable heating assembly) supported (directly or indirectly) by the shell and positioned as to heat a fluid provided within the cooking pot when in use. Also, a shell cover assembly (or cover) is provided which is supported by the shell main body. The cover being adjustable between a cooking pot cover position and a cooking pot access position, and the cover having first and second cover parts or sections that are adjustable relative to each other as to go from an extended cover position (or state) to a collapsed (or less extended) cooking pot access position (or state). An embodiment includes a cover that has a first connector, and the first and second cover parts are connected by the first connector such that an exposed surface of the first part and an exposed surface of the second part mutually adjust from a more common planar orientation when in the cooking pot cover position to a less common planar orientation when in the collapsed cooking pot access position. Also, an embodiment includes having a second connector and wherein the second cover part is adjustably connected by the second connector to the shell main body. In an embodiment the first and second connectors are each hinge connectors which work together as to provide hinge connection means, and the second connector is releasably secured in a tool-less manner to the shell main body.

An embodiment includes a first connector that is a pivot connector, and wherein one of the first and second cover parts includes a male projection flange in a region of the first connector and the second cover part includes a recessed region for receiving the male projection flange. This includes, for example, an arrangement wherein at least one of the recessed region and the male projection flange have one or more venting ports, as in, for example, an arrangement wherein each of the recessed region and the projection flange have one or more venting ports which are arranged for vapor passage from the cooking pot, though the cover (preferably via an intermediate positioned filter layer having vent apertures) and then to the environment.

An embodiment features first and second cover parts with each having an extended surface facing and wherein the extended surface facings are arranged essentially along a common plane extending over the cooking pot when in the extended cover position and wherein the extended surfaces are in a relative juxtaposed contacting or relative juxtaposed acute angle orientation when in the less extended cooking pot access position.

A further embodiment includes a cover that comprises a second connector with the first cover part having a free edge opposite an opposite end, with that opposite end connected with the first connector and the second cover part having a first end connected with the first connector and a second end pivotably connected with the second connector to the shell main body, and wherein each of the extended surfaces of said first and second parts face the cooking pot when in the extended cover position and face each other when in the less extended or compacted cooking pot access position.

An embodiment includes a cooking apparatus wherein the cooking pot is dimensioned to receive a whole turkey of 12 pounds (e.g., a range of 12 to 16 pounds or 12 to 18 pounds as a cooking pot suited for a greater than 12 pound turkey would also be dimensioned to receive a 12 pound turkey). The cooking apparatus is also preferably dimensioned to receive the cooking fluid (e.g., oil or water as examples of cooking fluid) with the cooking pot volume preferably being sufficient to generally uniformly heat the whole turkey as in a volume of cooking fluid sufficient to completely cover or substantially cover a whole turkey (e.g., 14 lbs.), as in a ⅔ inch maximum fluid level height below a horizontal plane lying flush with an uppermost surface of a whole turkey whether floating or not. A preference is to avoid going below a ½ inch uncovered with cooking fluid depth in the whole turkey to ensure a proper cooking; although, with extended cooking time from what might be recommended, there can be used fluid levels below a ½ inch uncovered level as in a ½ inch to 1 inch uncovered depth. However, extra cooking time would be required which can lead to overcooking in some turkey areas.

A further embodiment includes a cover having a window as in a window that is dimensioned and arranged as to be in only one of said first and second cover parts. Also, the window is sloped in an embodiment (e.g., a higher rearward edge to a lower forward edge—with forward being toward an operator standing in front of the apparatus in this embodiment). The view window (e.g., transparent or translucent window) is provided in an embodiment in the more forward of the first and second cover parts, with the rearward cover part being a windowless cover part that is connected to the shell main body via the second connector.

An embodiment includes a heating assembly as in a controllable heating assembly (combination of a controller, a heating device and heater support structure) with the controllable heating assembly including a heater support structure for supporting the controller and the heating device. An example of a heater support structure includes a heating unit support tower (e.g., an elongated casing which encases a control unit and from which extends the exposed portion of a heating element of the heating device with a configuration for a housing support structure including a triangular shaped corner recess filling tower). The heating assembly is designed for support by the shell assembly, as in a base of the shell assembly being configured to provide a nesting relationship relative to a male projection of the support structure of the heating assembly (or vice versa), with one embodiment featuring a recessed region that is formed in an upper surface of the base of the shell assembly that receives a lower positioned projection of the heater support structure as in a lower (polygonal periphery shaped) projection extending off the bottom of the noted heating unit support tower with a preferred location for the reception recess being in a corner region of that base (e.g., a corner region that is on a common side but an opposite corner as occupied by a spigot cover region of the cooking apparatus).

Further, in an embodiment of the invention, the cover includes a recessed section extending over an upper region of the heater support structure, as in a flanged cover portion designed to extend over in cantilever fashion an upper region of the heater support structure as in a triangular shaped flange cover portion that extends over an upper region of the above described support tower. The cover portion is further preferably provided with a grasping section as in one with a roughened or friction enhanced surface and/or a vent port. An example of a cover vent port is one that features a corner cover section having an interior flanged attachment section and an extended portion having a venting, interior aperture that is positioned to directly receive leaking fluid (e.g. steam, oil vapor, etc) that escapes near the location where the heating device and shell-cover interface (e.g., a location where there is a greater potential for fluid escape as in where heat resistance bars bridge an external support and the interior of the cooking pot). Also, in an effort to reduce the amount of leakage in that interface region, there is featured in an embodiment of the invention a seal device with one embodiment being a flexible seal (e.g., a seal material that also doubles as an insulator as in a silicone rubber material) having one or more recesses for receiving an exposed portion of the heating device (e.g., two slots formed in a vertically planar seal supported in a gap formed the above-noted interior flanged attachment section with the seal having apertures for receiving a bridging pair of resistant heat element rods forming part of a resistant heat element loop).

An embodiment of the heater support structure includes a heating unit support tower that includes a power connection port that is in electrical communication with the control unit which is also preferably contained in the heating unit support tower. Also, an embodiment of the heating device features a metallic resistance heating element with a section of the heating element being positioned as to extend along an outer wall (as in a stepped-in wall section relative to the adjacent surrounding wall portions) of the shell main body as well as internally within the heating unit support structure (e.g., within the support tower). The heating element also extends over an upper edge of the cooking pot (e.g., in bridging fashion through the above noted seal when the cover is closed) and then vertically back down into the cooking pot, and then more horizontally across the bottom of the cooking pot for heat communication with the cooking fluid, which in an embodiment is achieved via direct contact with the cooking fluid. An embodiment of the invention includes a heating assembly that is hand removable from the shell main body (e.g., with a friction slide release or alternate tool-less connection means such as key-slot connection).

For example, in an embodiment of the invention there is a friction insertion attachment of the heating unit support tower relative to the shell assembly as in a corner positioned tower that has a lower region that is in a projection/recess connection arrangement with a corner region of the base of the shell assembly. In a further embodiment, there is also provided a side wall friction catch relationship which has an electrical contact break/connection arrangement wherein, when the heater support structure is in its final position, the friction interfacing portions of the respective heater support structure and shell main body provide for a continued electrical contact from the plug-in reception port of the heating device to the resistance element extending into the shell main body recess. However, when that sliding friction engagement is released, the electrical connection is broken. Other electrical break providing means are also featured under the present invention as in other electrical contact arrangements such as one based on contacts provided relative to the above described male projection and female projection for the heater unit support tower and shell base combination.

An additional embodiment features a cooking apparatus wherein, when the cover assembly is in the compacted or less extended cooking pot access position, the first and second cover parts have axes of elongation that are more vertically oriented than horizontally oriented and then extend to essentially a common horizontal plane when the cover parts are adjusted to their cover mode. An example being a cooking apparatus wherein the cover includes a first connector and the first and second cover parts are connected by that first connector and the cooking apparatus further comprises a second connector connecting one of said first and second cover parts to the shell main body and wherein the shell assembly includes a stop (e.g., one that is extended off of the rear wall of the shell main body) as to provide for a fixed in position over-the-center vertical orientation in both the cover full extension (open access mode) and the cover collapsed while the cover is still in a cooking pot access position.

An embodiment features a shell body that comprises a spigot access aperture and a spigot access aperture closure member which is adjustable between a spigot access aperture closure state and spigot access state, and wherein at least one of the shell body and the spigot access closure member includes a biased lock member.

An embodiment of the cooking apparatus includes a shell body that has a generally rectangular configuration but for an indented or recessed corner region and that cooking apparatus further comprises a heating assembly comprised of a heating device and a control unit with there preferably also being a heating unit support structure. The support structure preferably is configured as to fill in the recessed corner region of the shell body as to provide a generally rectangular configured exterior side wall combination in the cooking apparatus. For example, an embodiment includes as the heater support structure a heating unit support tower and wherein the shell main body includes a first corner section which includes a recess for receiving the heating unit support tower and a second corner section which includes a cooking pot spigot base access aperture and a releasable cover extending about the second corner section.

A cooking apparatus embodiment comprises a food holder and the shell assembly further comprises an upper peripheral rim (e.g., an annular rim) that is supported by an upper wall region of the shell main body. The annular rim preferably includes one or more surface indentations which indentations include, for example, a catch indentation which is positioned for receipt of a catch portion of a food holder. One or more further indentations are also preferably provided in the annular rim as to provide for condensation capture recesses. In addition, the annular rim further preferably includes a pair of radially spaced vertically extending rim flanges and an intermediate peripheral ridge extending therebetween. Also, the cover has a corresponding peripheral ridge free edge designed for reception radially between the vertically extending rim flanges and in contact with the exposed upper surface of the base of the peripheral rim (i.e., the intermediate peripheral ridge) as to provide a generally sealed relationship between the lid and the peripheral rim. Preferably the cover ridge free edge is designed as to be in a radially intermediate region between the two vertically extending rim flanges as in closer to the radially outer rim flange than the inner flange. Also, a cooking pot with an upper concave curvature outer peripheral edge is designed as to receive the radially inner vertically extending flange therein. Also, the noted rim indentations (e.g., condensation capture recess(es) and/or food support capture hook reception recesses) are also preferably designed to be radially inward to both the radial outer vertically extending flange and the contact point of the cover ridge or edge with the exposed surface of the rim.

An embodiment of the cooking apparatus includes a cooking pot that is house shaped in horizontal cross-section (e.g., foundation side wall, left side wall, right side wall and smooth peaked roof wall combination with left and right sloped walls joined by a curved peak wall). Also, one or more (e.g., all or any combination of the noted walls) preferably feature vertical tapering with the taper going radially inward in going from top to bottom (e.g., converging radially inward downward). An illustrative taper amount is a range of 2.5 to 8° as in about a 5.5° taper. An embodiment features a taper on each of the noted walls as in one that provides for a preset maximum fill line location around the 33% to 40% in total cooking pot height with 0% representing the bottom location, and a preset minimum fill line that is in the intermediate region between the cooking pot base and the maximum fill line as in a 15 to 20% location. These maximum and minimum preferred preset fill line locations are designated by indicia (e.g., line stampings with our without word designations) on the pot. Also, the minimum line or designation is preferably within 3 inches of the central outlet axis for a drain spigot or outlet aperture provided at the base of the cooking pot (e.g., a 3 to 10% height location). Also in one embodiment the preset maximum fill line represents a 2 gallon cooking fluid level and the minimum preset level indicia representing a 1 gallon cooking fluid level. The total volume of the cooking pot is preferably in a range of 4 to 5 gallons with an illustrative embodiment's volume being about 4.8 gallons such that the 2 gallons represents about 35 to 45% of total cooking pot volume with an illustrative embodiment being about 42% as the oil level to pot capacity volume.

An embodiment of the invention includes a cooking pot that has a coated surface or laminate as in a metal cooking pot with a porcelain outer coating on the interior surface and preferably generally over the entire exposed surface of the cooking pot.

Also, the cooking pot preferably includes an upper cooking pot ring region extending vertically down from the curved upper peripheral rim of the cooking pot and which preferably has less of a diverging taper than the remainder of the corresponding side wall of the cooking pot (e.g., no taper as in a true vertical or a less than 3° taper for the upper ring region which is followed below by tapering sections of the respective side walls). Below the upper ring region, the above noted greater tapered side walls extend, but there is also provided strategically positioned non-or less tapered cooking pot reception recesses (e.g., small wall segments in the side walls having no or less taper that extend farther down from the upper ring region for less than a 25% length of the associated side wall region). The reception recesses also preferably extend peripherally for less than 50% of the peripheral length of the side wall (or side wall combination) in which they are provided. This preferably includes cooking pot reception recesses that are provided in the curved peak roof side wall and a diametrically opposed location on the foundation wall. An additional pot reception recess is preferably placed on a side wall (e.g., a 90° offset from the above noted diametrically opposed reception recess(es)) that is radially aligned with a capture hook reception recess in the peripheral rim and, as well, with the capture hook assembly of the food holder described below when mounted. In an embodiment two cooking pot reception recesses are positioned to receive therein (preferably in a non-contact with the cooking pot relationship) opposite grasping member pivot extension segments (e.g., curved rod extensions at pivot points for a bailing handle for a food holder basket or food capture rack) and the third reception recess is positioned to receive the above noted capture hook components of the same food holder basket or food capture hook or similar food holding means.

An embodiment of the cooking apparatus comprises a food holder that is a basket or food capture rack or the like. For example, an embodiment includes a food holder in the form of a basket having a depressed region for receipt of the heater device which depressed region (e.g., a depressed side wall region) is positioned as to be in better alignment relative to the heater device when the basket is in a catch relationship in the catch indentation of the upper rim than when in a cooking position in the cooking pot. The same food holder means also preferably is provided with a lower positioned bump-in or recess (e.g., a recess provided in the border region between a horizontally extending base portion of the food holder and a side wall as in a curved lower edge configuration with an added bump-in). The bump-in is strategically positioned as to radially align with a drain outlet aperture for the cooking pot as in one with an inner spigot and outer spigot segment extension relationship relative to the supporting cooking pot. Thus, the bump-in can receive the internal extension portion of the spigot with no or non-interfering contact with the food holder.

A cooking apparatus embodiment comprises a shell with a shell body and a reception cavity, and a cooking pot is removably received within the reception cavity of the shell. Further, a heater device is provided which is positioned as to heat cooking fluid received in the cooking pot when the cooking apparatus is in use. Also, a cover is provided which includes a first cover part as well as a first connector pivotably connecting the first cover part to the second cover part and a second connector, and wherein the second cover part is pivotably connected (directly or indirectly) to the shell main body by the second connector such that the cover is adjustable from a cooking pot cover extension position to a cooking pot access position. Also, the first connector provides for a collapsed state in the first and second cover parts when in the cooking pot access position, and wherein the cooking apparatus further comprises a cover stop member which retains the first and second parts in the cooking pot access position. Further the second connector is preferably an assembly that provides for both a pivot connection of the second cover part relative to the shell main body and also a release assembly for a locking engagement assembly.

An embodiment features a locking engagement assembly that includes one or more projections and recesses at the interface region between the second cover part and shell main body as in a block region supported by the shall main body having one or more (e.g., a spaced pair of projections) lock cavities that receives a corresponding one or more lock projections of the second cover part and a capture lock member for releasably fixing the one or more locking projections within one or more lock cavities. In one embodiment, there is provided horizontally outward biased capture lock members that extend out into capture contact with a pair of the lock projections with the locking engagement assembly preferably further comprising hand graspable release members as in a pair of pins that slide in a slot as to provide for lock disengagement and a pull out and separation of the entire cover assembly as for cleaning or servicing. The locking means like that described above is sufficient to avoid unintentional disengagement of the cover relative to the shall assembly.

An additional embodiment of the invention features a venting flange projection providing a male overlap segment of one of the first and second cover parts relative to the other as in one extending over a filter strip stored within a recess of that venting flange projection. An embodiment also includes a releasable venting flange projection as in one or more bias clips as in a pair of spaced apart bias clips as in one or more integrated flexible member(s) (e.g., flexible plastic engagement tabs) that can be flexed out of engagement as to provide for release of the cover flange projection as in a strip shaped flange projection generally conforming to and receiving a filter strip received therebelow.

Another cooking apparatus embodiment features a first connector that is a pivot connector, and wherein one of the connectors includes a male projection flange in a region of the first connector and the second connector includes a recessed region for receiving the male projection flange in an overlapping relationship, and the cooking apparatus includes a stop member for placement of the first and second cover parts while in the collapsed state in an over the center vertical orientation. In an alternate embodiment, within a space provided between a recessed portion of one of the male/female overlap segments of the cover parts, there is provided a filter strip which is aligned with venting apertures extending through one or both of the interfacing cover sections in the noted area of small pivot point overlap.

An embodiment includes a method of cooking a 12 pound or larger whole turkey, comprising inserting the turkey within a cooking pot retained within a shell body, covering over the turkey and cooking pot with a cover device, wherein the cover device includes a first cover part, a second cover part, a first connector pivotably connecting the first and second cover parts together and a second connector pivotably connecting the second cover part to the shell body, and lifting the cover device such that said first and second cover parts rotate as a generally planar unit until reaching a full open state (e.g., a blocked from further rotation location via a bock arrangement in the base pivot connection) as in a rotation position that is over-center. The method also features moving the inside surface of an upper or outer one of the cover parts toward an inside surface of the other, lower cover part such that the first and second cover parts are moved from a full extension full open state with the cover parts arranged generally planar and then to a collapsed cooking pot access position while the lower cover part remains in a full open state (despite the collapsed state). In an alternate embodiment there is featured a method wherein the first and second parts are adjusted into a collapsed state with a simultaneous rotation of the first and second cover parts both toward the extended cooking pot full access position and the collapsed state by rotating the first part toward the second part during the time the second or lower part is rotated to its over center state.

Thus, there is included an embodiment with a collapsing cover with the cover being a venting cover assembly with the venting region having multiple venting ports as well as a cover with a smaller view window which has insulated cover regions surrounding the window. The cover assembly further including a heating assembly as in one with a unit containment tower with an integrated control unit with the tower having a power cord plug in side receptor device.

An embodiment includes a cooking pot and shell configuration with a spigot containment and cover assembly. An embodiment further includes a shell perimeter rim having indentations such as a capture hook indentation as in capture hook reception indentation near the peripheral ridge for ready capture of the overhanging cooking pot. Also, an embodiment includes a heating unit tower top with a cantilevered recessed cover extension extending over the tower top (preferably also extending as well over the heating device's heating elements) and there preferably being provided a grasp facilitating portion on the cover extension as in a roughened outer surface and also there preferably being provided an aperture as in one that generally conforms in configuration to the upper surface of the heating assembly upper end (e.g., a triangular region at an upper end of a heating unit support tower). Also, there is preferably some degree of clearance overlap between the outer extremity of the cover extension (e.g., the outermost corner of the cover extension) and the underlying upper region of the heating device support structure as in a clearance area augmented by a peripheral sloped outer upper region in the heating device support structure below a cantilevered flange extension of the cover.

An embodiment also includes a cooking apparatus with cooking pot positioning means as in a series of projections extending up from the base of the shell which also position the shell so that a drain spigot, when included, is properly aligned with a shell spigot base access hole. Also, the spigot is preferably one having a screw cap and extension combination or kit for switching modes. The spigot base is preferably covered over with a removable access cover covering the spigot base access hole as in one with a biased locking catch. The spigot, when not in its extension mode, also preferably has the extension conduit stored within a cavity provided in the cover which also preferably has a second or shared compartment formed in it for receiving in storage fashion a power cord for the cooking apparatus.

An embodiment of the invention also features a method of deep frying food, as in a whole turkey having the above described dimensions, with the domestic fryer process involving inserting the food item (e.g., a whole turkey of 12 to 16 lbs.) into a cooking pot, and heating fluid in the cooking pot (and preferably covering or substantially covering (e.g., within ½ inch of top of food item) with 2 gallons or less of cooking fluid). The heating being carried out in an illustrative embodiment with an electric heater unit in direct contact with the fluid in the cooking pot.

A method embodiment includes having a cover assembly with first and second cover parts that are rotationally joined together and the combination pivotably supported by the shell main body as to provide for collapsing of the cover in a pot access position.

There is also featured a cooking method involving providing 2 gallons or less of a cooking fluid to a house shaped cooking pot having radially inward tapered side walls that is suited for receiving a 12 pound or more whole turkey and in which is also positioned a heating assembly.

Further featured is a method of assembling a cooking apparatus involving providing a shell main body with a recessed corner region and inserting a heating unit support structure to fill in that recessed corner region to provide a generally overall rectangular configured cooking apparatus. The recessed corner region also preferably being on a common side with an opposite corner positioned drain outlet access cover.

In the present application, a reference to “an embodiment’ is not meant to exclude the potential inclusion therein of component(s) or method step(s) of another referenced embodiment described in the application.

### BRIEF DESCRIPTION OF THE DRAWINGS

FIG. 1 shows a perspective view of a cooking apparatus embodiment.

FIG. 2 shows a front elevational view thereof.

FIG. 3 shows a rear elevational view thereof

FIG. 4 shows a left side elevational thereof.

FIG. 5 shows a right side elevational thereof.

FIG. 6 shows a top plan view thereof.

FIG. 7 shows a bottom plan view thereof.

FIG. 8 shows a similar perspective view as that of FIG. 1 but with the cover in a full open and collapsed state and with the heating assembly with control unit and heating device illustrated.

FIG. 8A shows an enlarged view of the circled region “A” in FIG. 8.

FIG. 9 shows a more frontal perspective view of that which is shown in FIG. 8.

FIG. 10 shows a front elevational view of that which is shown in FIG. 8.

FIG. 11 shows a rear elevational view of that which is shown in FIG. 8.

FIG. 12 shows a left side elevational view of that which is shown in FIG. 8.

FIG. 13 shows a right side elevational view of that which is shown in FIG. 8.

FIG. 14 shows a bottom plan view of that which is shown in FIG. 8.

FIGS. 15A to 15I show different positions of cover assembly movement.

FIG. 16 shows a top plan view of that which is shown in FIG. 8 but with the cooking pot removed.

FIG. 17 shows a perspective view of that which is shown in FIG. 8 but with an added food support device or food handler and a grasping handle in engagement with the food support device.

FIG. 18 shows a more frontal perspective view of that which is shown in FIG. 17 with the food support device having been lifted and shifted into a grasping relationship with the side of the cooking pot and its shell interface.

FIG. 19 shows another view of the food support device having been lifted and shifted into a grasping relationship with the side of the cooking pot and its shell interface.

FIG. 20 shows a top plan view of that which is shown in FIG. 19.

FIG. 21 shows a front elevational view of that which is shown in FIG. 19.

FIG. 22 shows a view of the embodiment of FIG. 1 with the drain access shell cover removed and with the drain spigot base being capped and in its normal cooking mode.

FIG. 23 shows a same view as FIG. 22 but with a drain extension connected and the drain spigot in its extended mode.

FIG. 24 shows a perspective view of the drain access shell body cover.

FIG. 25 shows a top plan view of the drain access shell body cover and the storage compartments provided.

FIG. 26 shows a perspective view of the embodiment of FIG. 1 with a food support device or food holding means in the form of a basket and with that basked in a raised up catch engagement state with respect to the shell main body.

FIG. 27 shows a top plan view of that which is shown in FIG. 26.

FIG. 28 shows a partially exploded view of the embodiment of FIG. 1.

FIG. 29 shows a partially cut away view of the embodiment of FIG. 1 with the cooking pot and cooking pot position projections illustrated.

FIG. 30 shows a top plan view of an embodiment of the cooking pot.

FIG. 31 shows an elevational view directed at a right side rear panel of the cooking pot.

FIG. 32 shows a front elevational view of the cooking pot.

FIG. 33 shows a perspective rear-right side view of the cooking pot.

FIG. 34 shows a perspective right front side view of the cooking pot.

FIG. 35 shows a bottom perspective view of the cooking pot from a rear-right side direction.

FIG. 36 shows a bottom perspective view of the cooking pot from a right-front side direction.

FIG. 37 shows a view similar to FIG. 34 but with the spigot in a cooking mode.

FIG. 38 shows a view similar to FIG. 34 but with the spigot in an extended mode.

FIG. 39 shows an elevational view of the cooking pot with a view direction directed at the right rear side wall which is shown as having the capture hook bump-out.

FIG. 40 shows a cross-sectional view taken along cross-section D-D and showing the concave portion of the foundation wall bump out of the cooking pot.

FIG. 41 shows an enlarged view of that which is shown in FIG. 31 with added cap on the spigot base and with taper reference lines provided.

FIG. 42 shows an enlarged view of that which is shown in FIG. 32 with added cap on the spigot base and with taper reference line provided.

FIG. 43 shows a cut-away view of the cooking apparatus in an orientation as in FIG. 4 with the food support device in its lower or cooking position.

FIG. 44 shows a cut-away view of the cooking apparatus in an orientation as in FIG. 4 with the food support device in its raised or drain position (with the lid retained closed in this illustration).

FIG. 45 shows a cut-away, cross-sectional view of the shell assembly in a forward to rearward view orientation and with the cross section line extending side to side through the front view window.

FIG. 46 shows a bottom perspective view with the cooking apparatus in a drainage or cooking fluid release mode with the access door opened.

FIG. 47 shows the access door's storage compartments in a pre-storage mode relative to storage members in the form of a spigot extension component.

FIG. 48 shows a view similar to FIG. 47 but with an additional view of a power cord as a storage member stored in the access door while in a storage mode.

FIG. 49 shows a rear view of the cooking apparatus but with the covering over the locking engagement assembly removed for better visualization of the same.

FIG. 50 is an enlarged view of the circled area “A” in FIG. 49.

FIG. 51 shows a bottom view of the base of the shell assembly.

FIG. 52 shows a perspective view of the base in FIG. 51.

FIG. 53 shows a side elevational view of the base.

FIG. 54 shows a top plan view of the cooking apparatus in a full access mode and with an alternate food support structure embodiment in the form of a rack device in a lowered cooking mode.

FIG. 55 shows a perspective view of that which is shown in FIG. 54 but with the rack device in a raised state and engaged with the peripherally located recessed rim section.

FIG. 56 shows a top plan view of the rack device shown in FIG. 54 with the bailing handle down.

FIG. 57 shows the rack assembly of FIG. 57 in perspective and with the bailing handle in a raised position.

FIG. 58 shows a front elevational view of the rack device.

FIG. 59 shows a side elevational view of the rack device.

### DETAILED DESCRIPTION

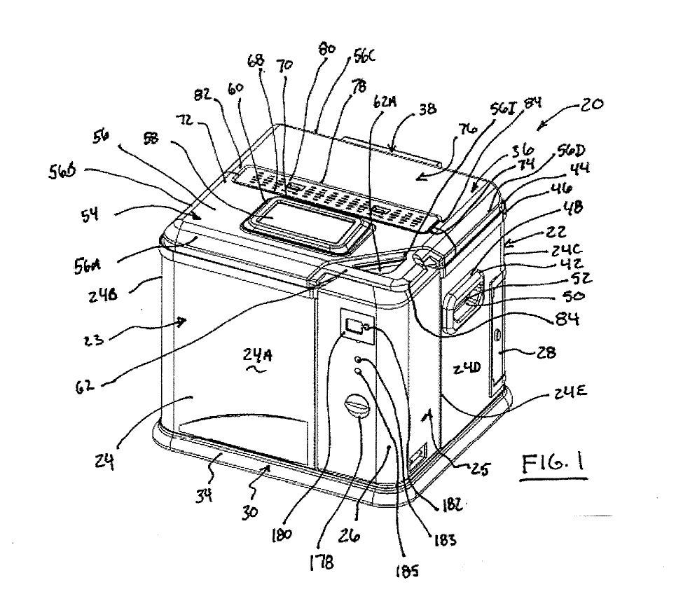

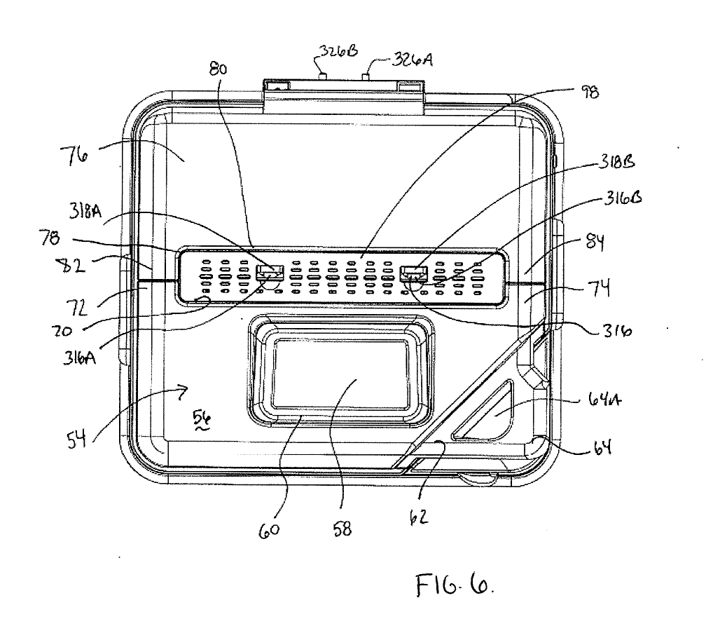

An embodiment of the present invention is shown in FIGS. 1 to 7 and features a cooking apparatus 20 comprising shell assembly or shell 22 comprising shell main body 23 having peripherally extending external wall 24, which in this embodiment features front side wall 24A, left side wall 24B, rear wall 24C and right side wall 24D. Shell assembly 22 further comprises heater support structure with an outer smooth cornered, angled wall surface which helps in completing the overall rectangular configuration in the cooking apparatus 20 shell assembly further includes shell access panel section 28 forming part of external wall 24 together with side wall portions 24A to 24D. Shell assembly 22 further includes base 30 with flanged base portion 34 and bottom panel 32 (FIG. 7), from which extends individual projection feet 33 which are each shown as having a rigid base and an elastomeric extremity (e.g., elastomeric or high friction pads well suited for counter top mounting). Projection feet 33 are further shown as being in each of the four corner positions for the bottom base panel with a similar projection foot 33 positioned at a central location.

Shell assembly 22 is preferably made of a relatively sturdy material such as steel and/or a heavy gauge aluminum and/or a plastic or a combination of materials (either component to component or a composite material for individual component(s)). Also, shell assembly components such as external wall 24 of shell main body 23 have a single wall design or a multi-wall design as in a double walled shell with or without intermediate insulating material (not shown). A similar configuration as used in one external wall shell assembly component is preferably utilized for other shell assembly components as in, for example, control unit shell section 26 and/or the below-described shell access panel section 28 and/or shell cover assembly 36. In an alternate embodiment the main shell body is a double walled shell component while another components as in the access panel are of a single wall design.

Shell cover assembly 36 (or “cover assembly” or “cover”) is shown as covering over shell main body 23. Cover assembly 36 is shown connected to cover interface device 38 which provides connection means (e.g., a hinge) between cover assembly 36 and an underlying structural component of the shell assembly as in shell main body 23. Also, the cover assembly 36 is preferably generally made of cover parts of a single layer or wall, but alternate embodiments feature, for example, a double walled design with or without added insulation material therebetween.

Shell assembly 22 further includes grasping handles 40, 42 shown in the figures to be positioned oppositely on the shorter length left side wall 24B and right side wall 24D, and below outer perimeter flange 46 of annular rim 44. Grasping handles 40 and 42 are preferably at least partially recessed inward of the exterior surface of the associated side walls 24B and 24D, with an embodiment including rectangular ring shaped handles each featuring a rectangular projection ring 48 extending about an insert body section 50 defining finger cavity 52. These grasping handles are useful for carrying the fully assembled cooking apparatus from one location to the next as when all cooking fluid has been drained.

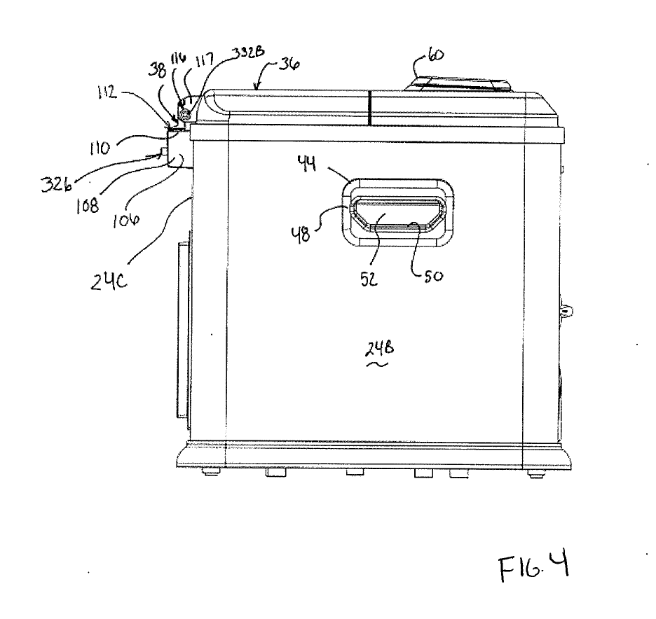

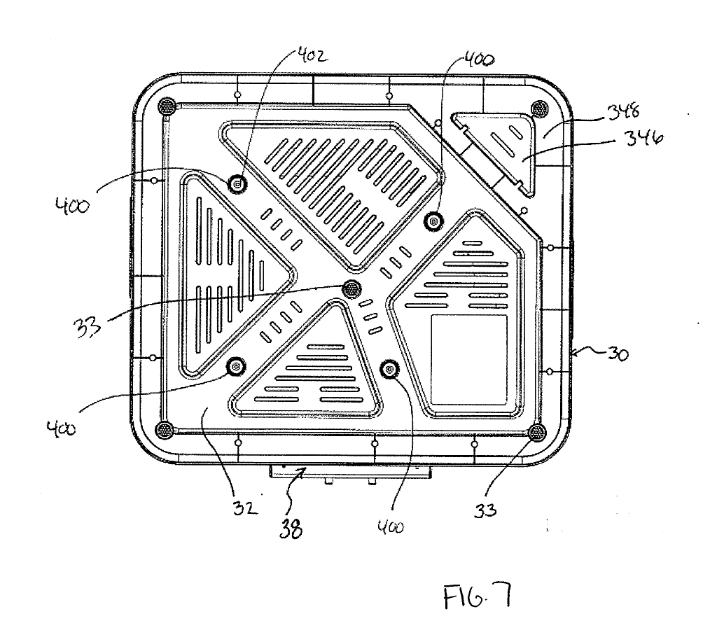

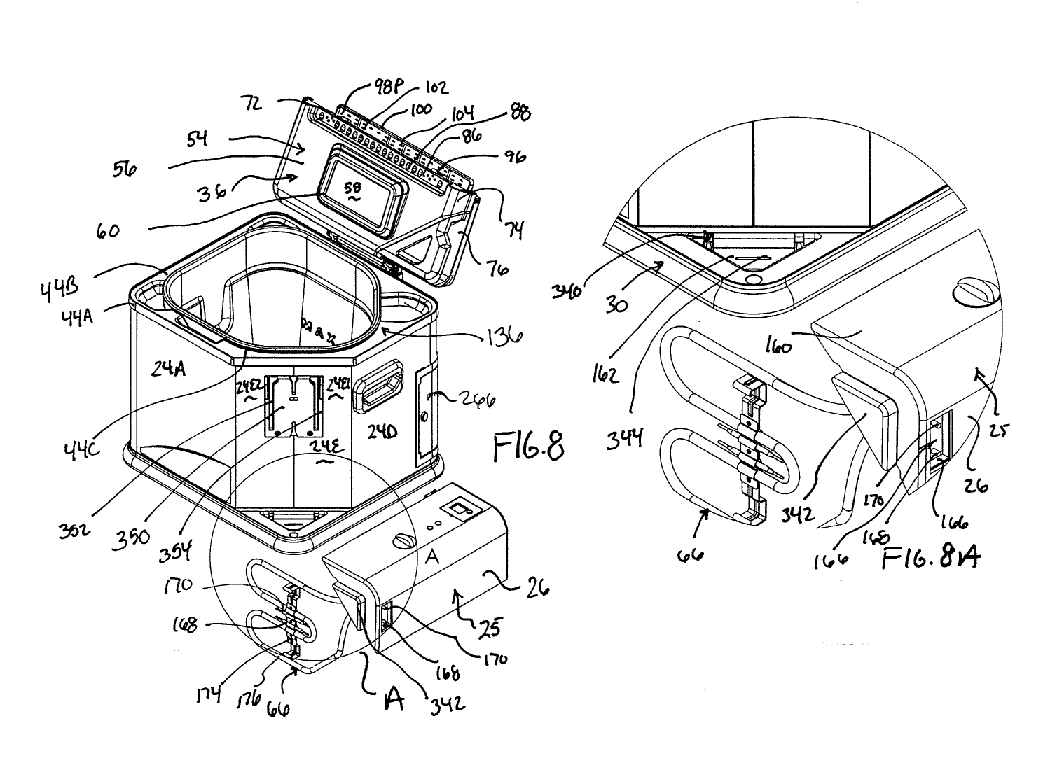

With continued reference to FIGS. 1 to 7 as well as FIG. 8, there is provided a more detailed discussion of an embodiment of shell cover assembly 36 which includes a first cover section or part 54 which is shown extending to a forward edge region of front wall panel 24A and to opposite side walls 24B and 24D. Front (or first) cover section or part 54 is shown as comprising a generally planar main cover segment 56 in which is formed viewing window 58. Viewing window 58 is further shown as projecting up off the plane of the upper surface of main cover segment 56. As seen from FIGS. 1 and 4, viewing window features a peripheral frame (e.g., rectangular) structure 60 which extends off the upper surface of main cover segment 56. Also, there is featured in the viewing window shown 58 a viewing (e.g., transparent or translucent) panel supported above the upper surface of main cover segment 56. The viewing panel or pane is also shown as having an incline as with the rear end being at a higher elevation compared to the front edge as by having the peripheral rear portion of frame structure 60 rising at an incline as shown in FIG. 5 (e.g., a slope of less than 20° with 10° to 15° being illustrative).

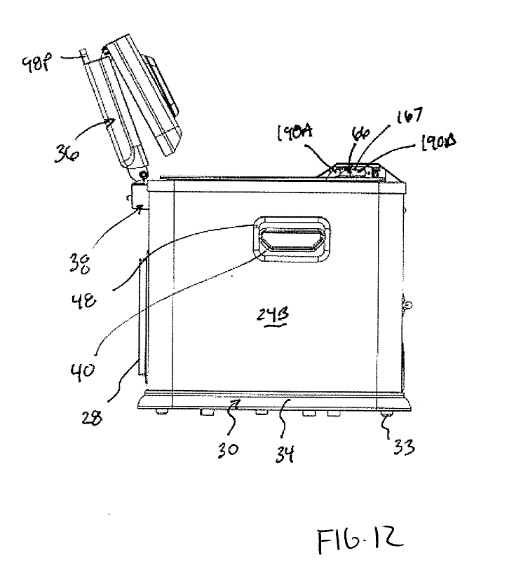

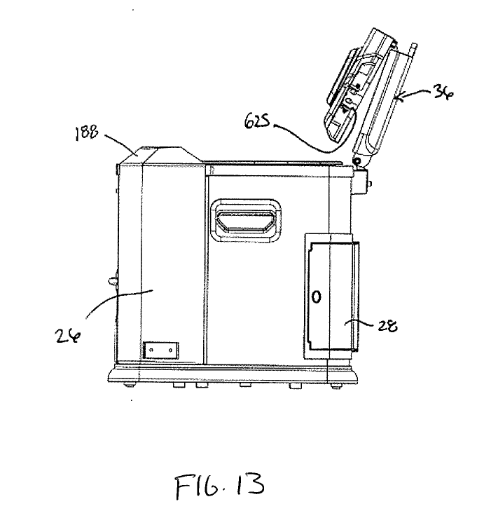

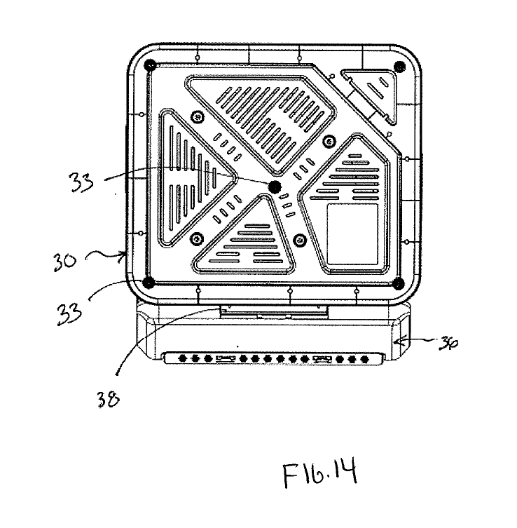

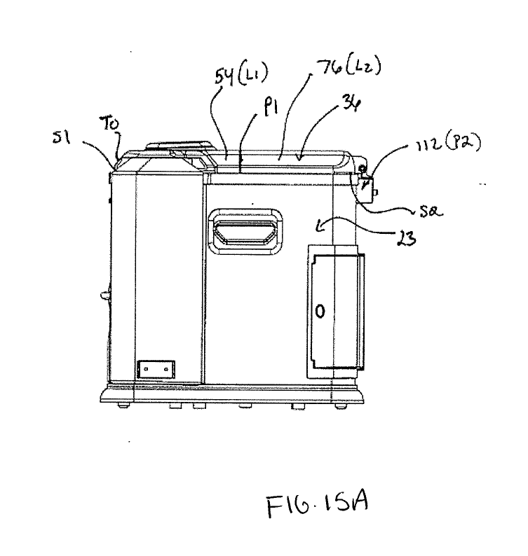

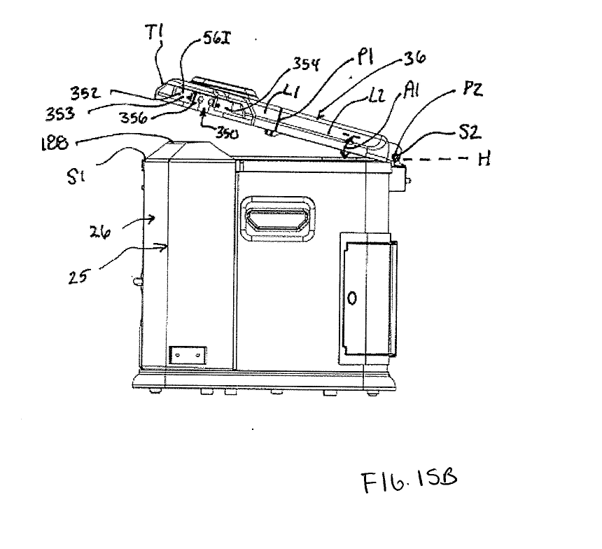

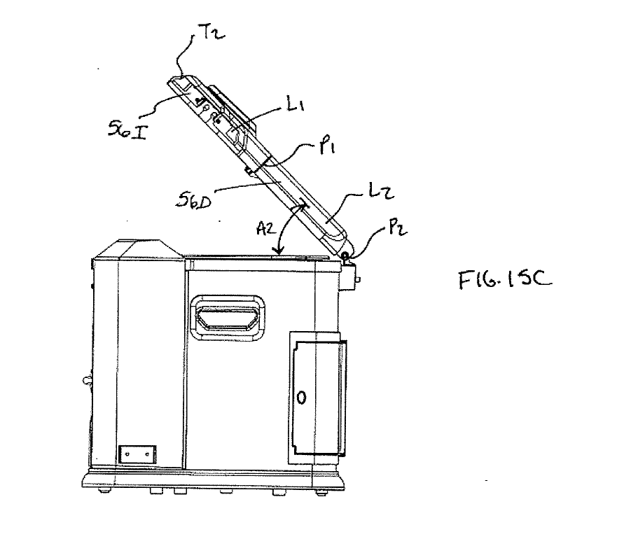

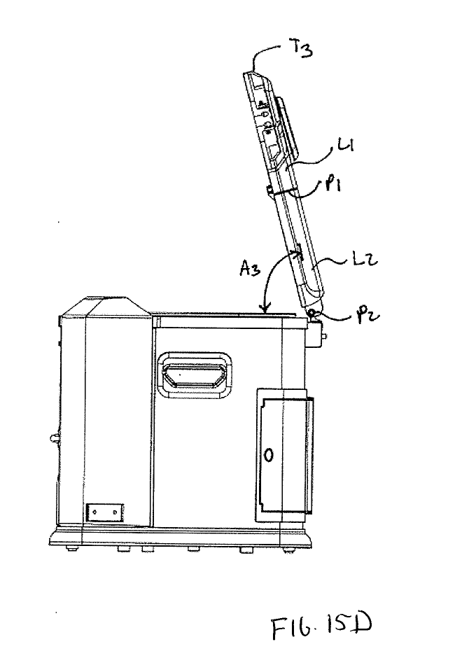

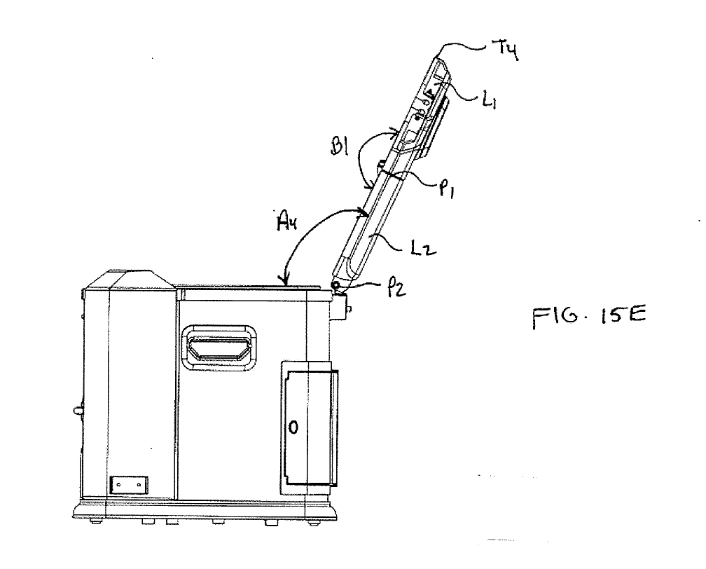

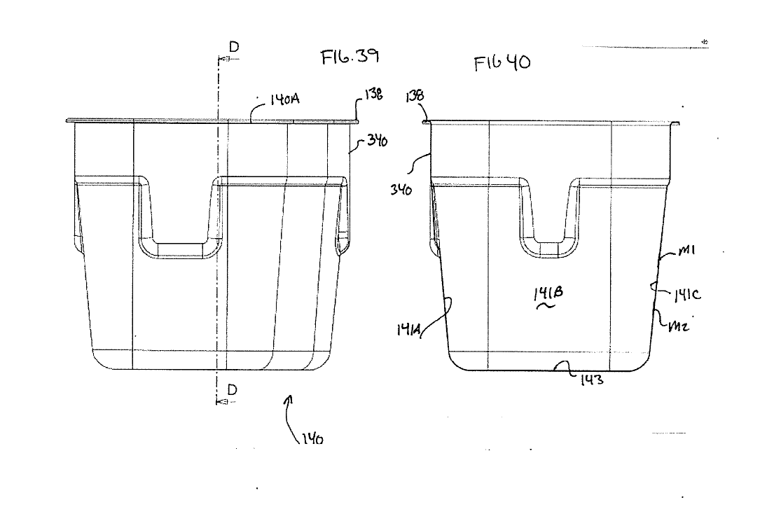

The viewing window 58 is shown as being generally centrally positioned in the cover segment 56 (and hence offset relative to front to rear length of the entire cover assembly 36 with a favoring to the front side of the intermediary front to rear demarcation). In addition, as shown in FIG. 1, the cover segment 56 further includes front (56A), left (56B), rear (56C), right-rear (56D) and right-front (56I) vertically sloping or tapering flange surfaces which taper from a generally planar interior portion of a cover segment into a generally vertically coincident relationship with an exposed generally planar intermediate portion 44B (FIGS. 16 and 45) of annular or peripheral rim 44. The free edge 56E of each of tapered flange surfaces 56A to 56D and 56I (a corner cut off edge) is illustrated in greater detail in FIG. 45 as is the receiving intermediate portion 44B of annular rim 44 and the radially spaced exterior rim flange 44A and interior rim flange 44C shown in FIG. 45 as each extending vertically above and below the plane represented by intermediate portion 44B of annular rim 44. As shown in FIG. 45, vertically tapered flange section 56I (see FIG. 15C) defines the interior portion of a recessed corner section in the cover assembly 36 and is shown with a more abrupt vertical drop (e.g., a more direct vertical drop as in an essentially 90° bend from the main cover segment 56 as compared to the more gradually sloped or curved other tapered flange surfaces represented by 56A to 56D).

Cover 36 further includes a cantilevered extension section 62 shown as being a stepped down, triangular corner cantilevered extension section in this embodiment with its initiation being at a location adjacent to an adjacent front corner of viewing window 58. Extension section 62 also features outer tapered flange rim 64 as well as an interior aperture 64A. Interior aperture 64A is shown as preferably having a common “triangular” configuration as does the extension section 62 in general. Extension section 62 extends over the upper region of heater support structure or heater control unit shell section 26 in cantilever fashion with a base flange 62F which is bolt mounted to the flange section 56I of cover part 54. Also, as explained in greater detail below, extension 62 also preferably covers over redirection segment section 67 of heating device 66 (FIG. 8) with the flange 62F (and/or 56I) also providing a support for a seal strip 62S (FIG. 13) as in a silicone strip with suitable heat element reception apertures (as described in greater detail below). Cover segment 56 further includes rear edge 68 having a recessed intermediate edge region 70 which is closer to the front edge of 56F than the smaller rear edge segments 72, 74 positioned at opposite, respective ends of rear edge region to generally define a U-shape configuration.

Shell cover assembly 36 further comprises rear (or second) cover section or part 76, which, but for the differences presented by extension section 62, is shown as being generally symmetrical relative to the front (or first) cover section 54. This includes a front edge 78 having a recessed rear edge region 80 which is farther from the front edge of 56F than the (shown smaller in this embodiment) rear edge segments 82, 84 of that front edge 78, and which are positioned at opposite, respective ends of that front edge to generally define a U-shape configuration.

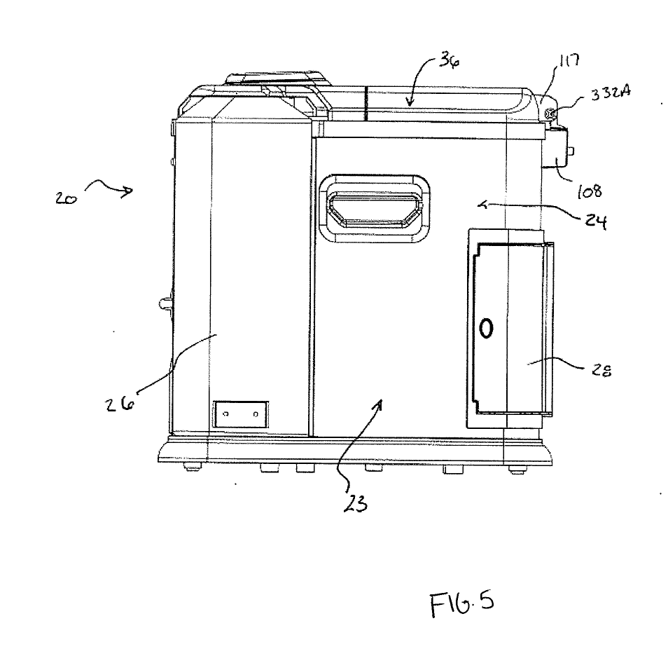

As shown best in FIG. 6, when cover assembly 36 is in a closed state, the respective legs represented by segments 72, 74 of the front cover section 54 are in essentially flush relationship (e.g., contact or less than 5 mm spacing) with the corresponding leg segments 82 and 84 of rear cover section or part 76. As best shown in FIGS. 8 and 9, extending between the opposing inner surfaces of leg segments 72 and 74 and rearward of rear edge 70, is reception panel 86 that is recessed relative to the upper surface of cover section 54 (with 70, 72 and 74 representing a step up border region relative to recessed reception panel 86).

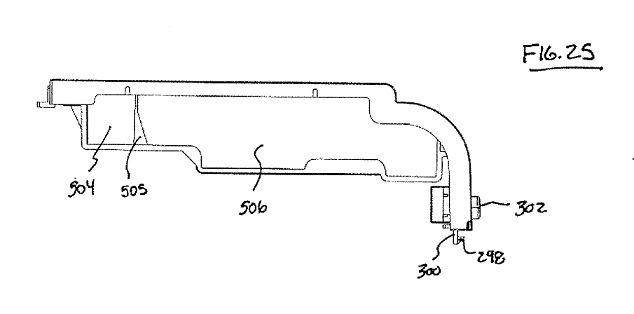

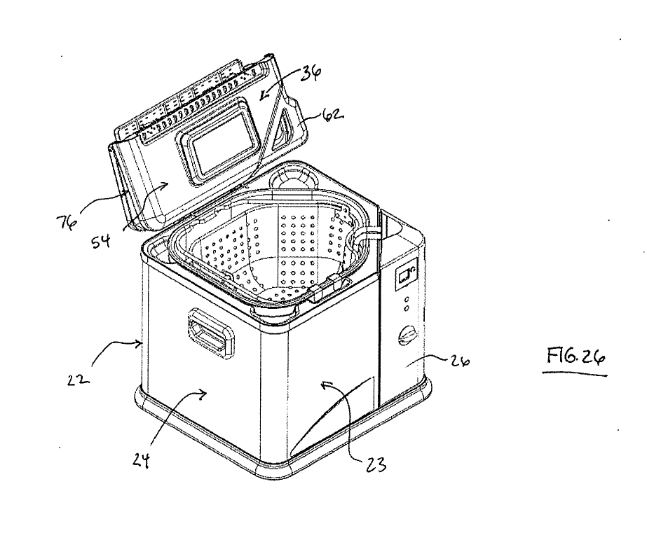

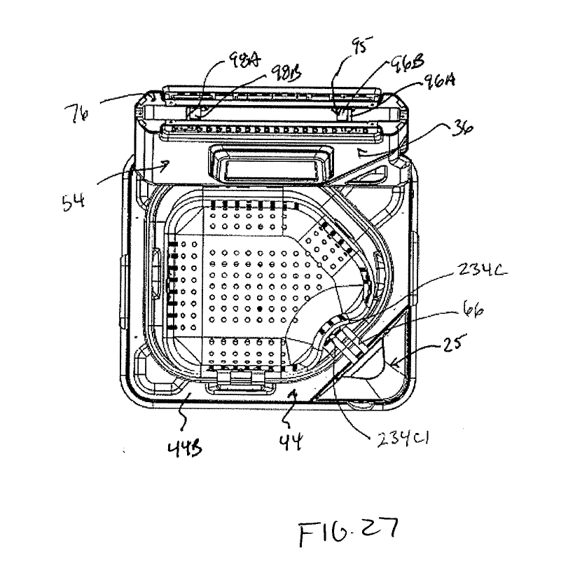

Reception panel 86 is also shown in FIG. 8 as having a free edge generally corresponding with the free edges of the leg segments 72 and 74. Reception panel 86 further includes a plurality or apertures or ports 88 which in this embodiment are shown spaced along a majority of the length of elongation (right to left) with there being spaced apart solid regions 90 and 92 adjacent a pair of ports 88 positioned at opposite respective ends of panel 86. The solid regions provide mounting support for hinge device 96 which is shown in this embodiment as being a hinge assembly with a male/female engagement relationship with one or more of the male and female projections secured to the noted panel at the solid regions 90, 92 and the corresponding one or more male and female hinge components being connected to the rear cover section 76. In this embodiment, there is provided a pivot post and pivot reception base combinations 96A, 96B and 98A, 98B (FIG. 27) to form hinge means 95 or first connector comprised of hinges 96 and 98.

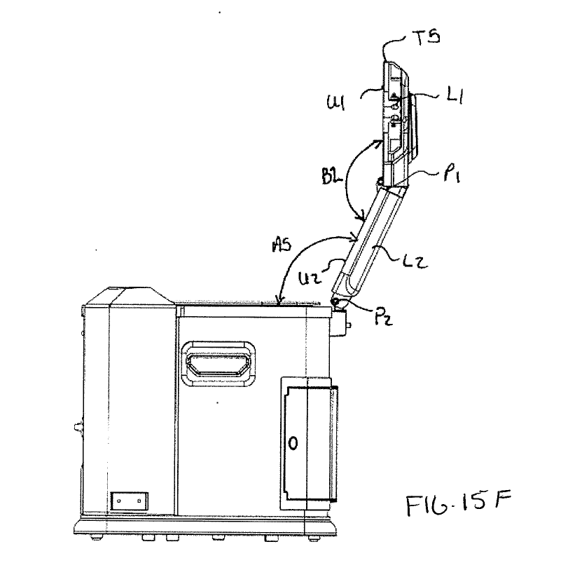

As best shown in FIGS. 8 and 17, cover assembly 36 further includes a venting reception panel segment 98P which is shown supported by rear cover section 76 (or forming an integrated (e.g., monolithic relationship)) with rear cover section 76, and having rear and side edging conforming to the symmetrical stepped relationship corresponding to the step down wall forming opposing inner surfaces of leg segments 72 and 74 and the intermediate portion of rear edge 70. In the illustrated embodiment, the panel segment 98P has a generally elongated rectangular (e.g., smooth cornered) configuration. Also panel segment 98P preferably has a reverse tray configuration with a peripheral flange 100 designed for contact with reception panel 86 at its free edge and a main tray panel 102 featuring a plurality of apertures or vents 104. As seen from a comparison of reception panel 86 and tray panel 98P, the vents 104 are preferably more numerous in number and smaller in size than the ports 88 in reception panel 86 (e.g., a plurality of narrow rectangular configurations or slots for tray panel 98P and circular ports of larger area for ports 88).

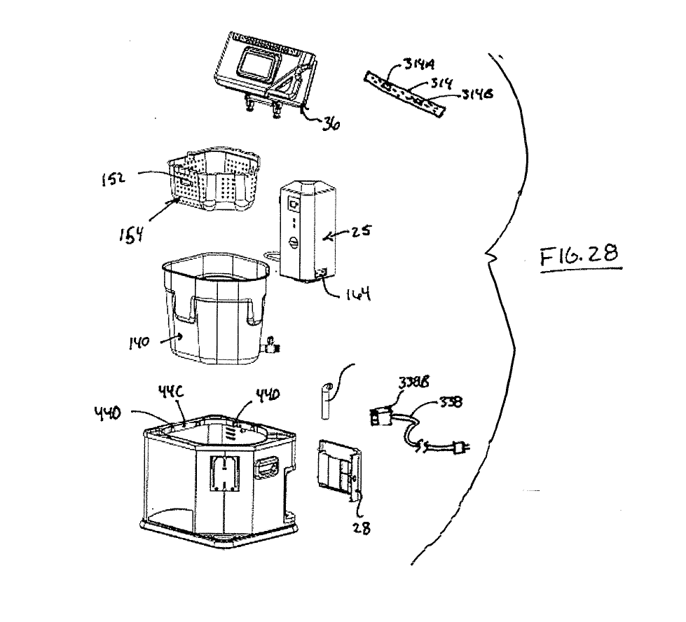

With reference to the exploded view of FIG. 28 and the cut-away view portion of FIG. 17 there is seen filter 314 and which is provided with holes 314A and 314B for reception of the below described L-shaped connectors for holding down projection panel 98P. In a preferred embodiment filter 314 is a strip of filter material that is sized for reception in the cavity defined by main tray panel 102 and peripheral flange 100. Thus, filter 314 is retained in position via its nesting arrangement within the cavity defined by the male projection panel or panel segment 98 extending out from second cover segment 76. In an embodiment, panel segment 98P is formed of a different material than the supporting portion of cover segment 76 as in a metallic cover body for cover segment 76 and a plastic tray for panel segment 98. An embodiment of filter 34 includes a strip of metallic foil or the like have a plurality of slits formed in it to allow for the appropriate vapor release. A strip of aluminum foil with punched out strips is illustrative. Alternate embodiments of filter 314 includes laminates with enhanced filtering performance of plastic or metal design as in a filter with an odor absorption layer (e.g., a charcoal layer as in one formed between outer cover strips of foil) as but a few examples of filtering means 314 in this exhaust region of the cover assembly 36. In similar fashion as to the projection panel 98, the width of the filter 314 is preferably designed to extend to opposite sides of the rearward edge of front cover section 54 and the forward edge of cover section 76 which are designed to abut each other (or be in essentially flush, sealing relationship) upon cover assembly closure to seal the cover with reliance placed on the venting ports such as 88 for vapor release. The filter 314 is thus accessible within the nested location provided by the undersurface of projection panel 98P such that a rapid replacement of a cleaned or new filter can be accomplished. Thus, in this embodiment, the vapor released from the top of the cooking apparatus includes vapor passing through the ports provided in the rear end region of the first cover section 54, through the filter, when inserted, and also through the apertures 104 in projection panel 98.

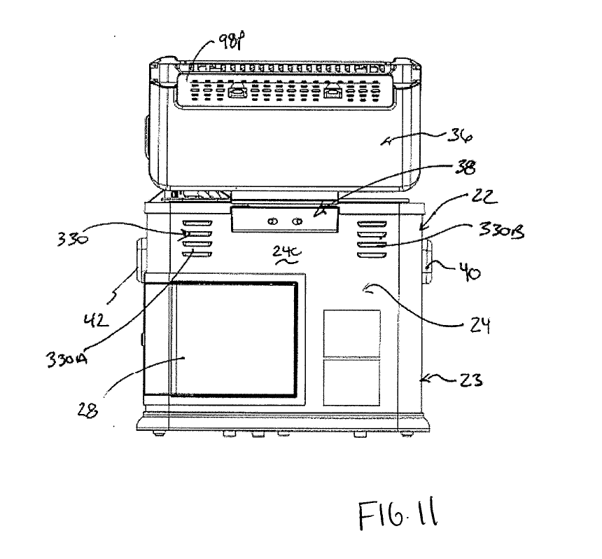

Also, as seen from FIGS. 6 and 14, the projection panel is releasably secured in position on cover assembly 36 as by way of one or more releasable connectors or connection means 316. In an embodiment of the invention there is provided connection means 316 comprised of a pair of connectors 316A and 316B that are formed in, for example, the intermediate region of projection panel 98P and preferably integrally formed as finger release biased projectors designed for engagement with corresponding catch supports 318A and 318B such as a pair of L-shaped catch supports extending upward off the front positioned recessed edge region 80 of cover section 76 between the front edge segments 82 and 84. Upon finger release of connectors 316A and 316B the projection panel can be washed separately as in a dishwasher as it is in an area where material can pass through via the vapor exhaust path.

While a front to rear collapsing cover assembly 36 is shown as a preferred embodiment of the present invention, the present invention is also inclusive of other cover assembly arrangements as in left to right or right to left rotation relative to a base hinge or adjustable connection means or rear to front as a few additional examples. Also, an alternate embodiment includes an opposite main body hinge support with over center rotation capability as in a missile silo like opening arrangement and with the meshing central region with projection tray 98P like that described above.

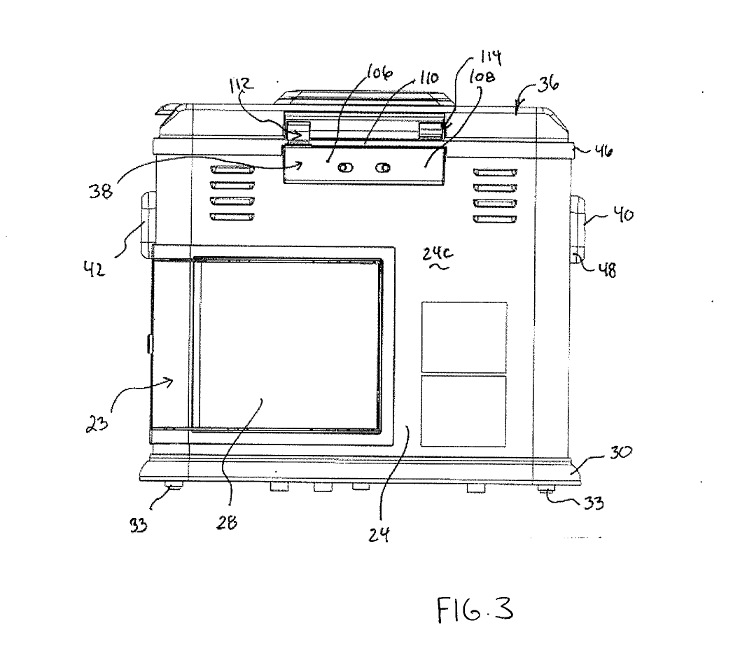

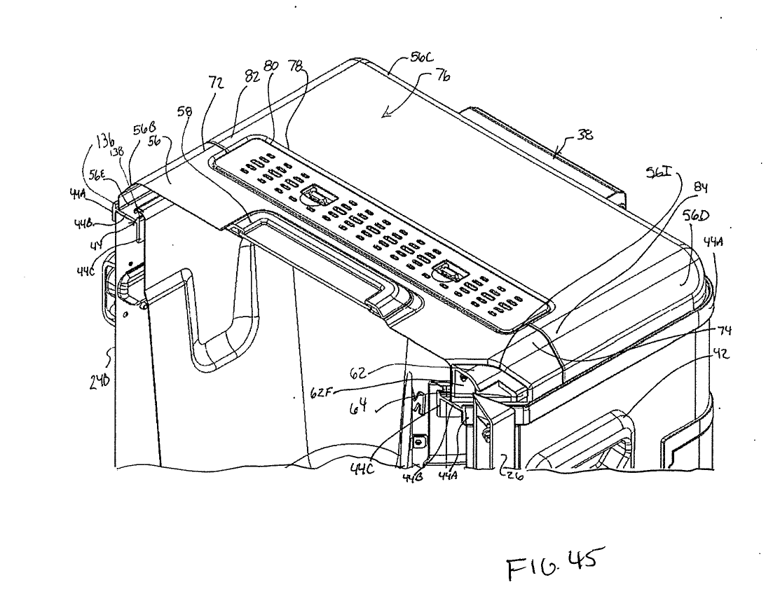

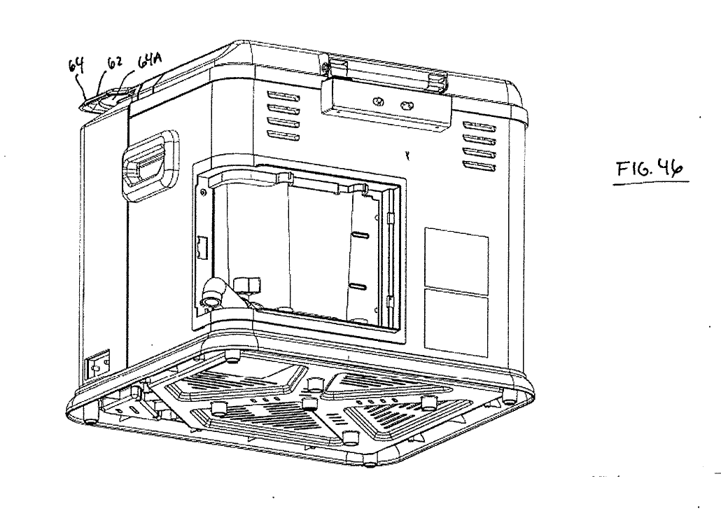

With reference to FIGS. 3, 4, 6 and 9, as well as FIGS. 49 and 50 there is seen shell main body 23 and cover interface device or second connector 38 which comprises support device 106 which, in this embodiment, is shown as including projecting body 108 supported by shell main body 23 as in a secured support block (or blocks) joined to external wall 24 (e.g., rear wall 24C). As shown in FIG. 4, support block 108 is a unitary, hollow elongated block extending centrally along an upper region of the rear wall surface 24C and has an upper support surface 110 upon which is mounted base hinge device 112 of cover-to-main hinge assembly 114.

As shown in FIGS. 49 and 50, the elongated block 108 forms part of locking engagement assembly 320 that includes, in this embodiment, lock cavities 322A and 322B designed to receive in plug fashion lock projections 113A and 113B described in greater detail below. There is further shown in FIGS. 49 and 50 a biasing capture lock assembly 324 that is received within the hollow body of block 108 and positioned for releasably fixing in place the one or more locking projections within one or more lock cavities (two of each shown in the illustrated embodiment). In the illustrated embodiment for capture lock assembly 324 there is provided horizontally outward biased capture lock members 324A and 324B that are biased outward by bias spring 324C which is connected to spring capture projections of the facing ends of lock members 324A and 324B. The opposite ends of lock members 324A and 324B feature cam surfaced free end projections 324D and 324E that respectively extend out into capture contact with the pair of the lock projections 113A and 113B which have cam reception cavities 113C and 113D along their length.

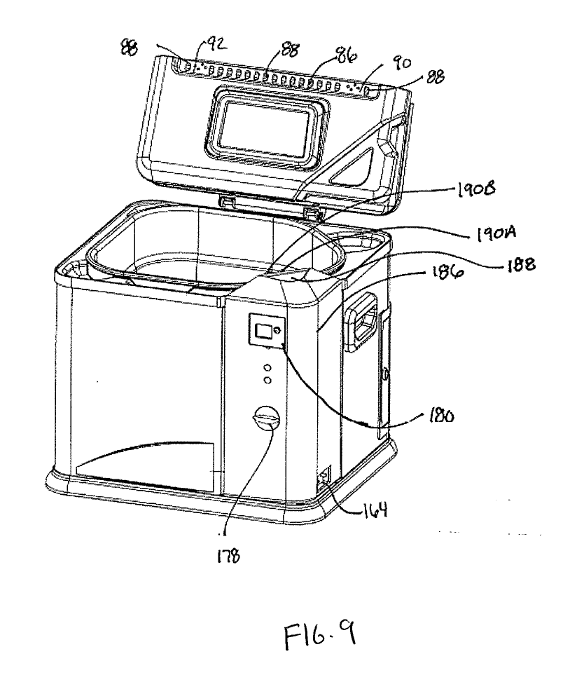

Locking engagement assembly 320 is shown as further comprising hand graspable release device 326 which in the illustrated embodiment features finger contact members 326A and 326B which, as best seen in FIG. 11, are a pair of exposed pins that slide within respective slots 328A and 328B formed in the projecting body. As seen in FIG. 11 the pins 326A and 326B are spaced a suitable distance apart as to provide for a user to, with a single hand, bring together lock members 324A and 324B until their cam surface free ends 324D and 324E disengage as to allow for a user to pull out the entire cover assembly 36 with the other hand from its reception and support relationship provided by interface device 38. The disengagement via a pull out and subsequent separation of the entire cover assembly from the remainder of the shell assembly facilitates cleaning or servicing. The lock members 324A and 324B are biased outward by spring 324C such that upon reinsertion of the projections 113A and 113B the cover assembly is reengaged with the shell main body 23 as to not be inadvertently separated until a desired time for cover assembly disengagement. The locking means like that described above is preferably sufficient to avoid unintentional disengagement of the cover assembly relative to the shall assembly. As further shown in FIG. 49, cooling channel means 330 such as a pair of cooling channel vent sets 330A and 330B spaced to opposite sides of projection body 108 are provided. As described below in the discussion of the base of the shell assembly 23, the channel means 330 provides for a cooling air flow pattern involving the lower intake of cool environmental air into one or more lower apertures (e.g., base apertures) then through a flow conduit defined by the exterior of the cooking pot and interior of the shell main body as in one where cooling air is inherently drawn in from the base region of the shell assembly and inherently vented out via channel means 330.

With reference again to FIGS. 3, 4, 6 and 9, as well as FIGS. 49 and 50 interface device 38 comprises base hinge device 112 of cover-to-main hinge assembly 114. Hinge device 112 is shown as including cover hinge device 116 which in this embodiment includes an elongated cover supported hinge projection body 117 that is shown secured to the tapering rear portion of cover section 76 and having projection base reception apertures 116A and 116B in which is received the base portions 112A and 112B of the aforementioned projections 113A and 113B. Reception apertures 116A and 116B represent hinged capture ends in projection body 117 by way of pivot posts 332A and 332B (FIGS. 4 and 5) which extend though suitable holes formed in base portions 112A and 112B of the aforementioned projections 113A and 113B which can be sections of a single pivot post shaft extending along the entire base hinge device 112.

Further there is also preferably provided in hollow cavities formed in each of base portions 112A and 112B a bias member CS (represented in FIG. 50 by coil springs CS1, CS2) wrapped around a respective shaft section and fixed at one end to the cover hinge device 116 and at an opposite end to a respective one of the projections 113A and 113B as to provide a rotation facilitation quality to the cover when being moved from its cover state to the full open but not yet collapsed state. Also, as seen in FIG. 50, base reception apertures 116A and 116B include contact edges 334A and 334B at the top region of apertures 116A and 116B which represent contact stop edges relative to intermediate contact grooves 336A and 336B which when in contact define a rearward rotation stoppage point in the cover assembly relative to the shell assembly 23, with the bias members CS internalized in the base members providing the upward rotation bias in the projections 113A and 113B (relative to the cover itself and hence a facilitation in the raising of the cover assembly relative to the shell assembly when the projections 113A and 113 are locked in position to the cover assembly 36).

With reference to FIGS. 8, 16 and 20, an intermediate region of shell cover assembly 36 includes connection means or first connector 95 as in cover section hinge devices 96 and 98 which pivotally connect the rear edge region of front (or first) cover section 54 to the front edge region of rear (or second) cover section 76. Connection means 95 includes in the illustrated embodiment pivot post and pivot reception base combinations 96A, 96B and 98A, 98B as shown in FIG. 27 comprising stub projections 124A and 124B extending downward (when cover assembly is in a closed state) from the rear edge region of first cover section 54 (and hence in a forward to rearward direction when the cover assembly 36 is in a full open state). In addition to the downward stub projections 124A and 124B of combinations 96A and 98A, there is preferably provided horizontally extending stub posts designed to extend into the also vertically downwardly extended reception projections 126A and 126B of combinations 96A and 98B to hingedly connect first and second cover parts 54 and 75 (with “connected” in the present application being inclusive of components fastened directly or indirectly or an integrated relationship as in a monolithic body formation such as through plastic injection techniques). Reception projections 126A and 126B extend downward (when cover assembly 36 is in a closed state) from the front edge region of second cover section 76 (and hence in a rearward to forward direction when the cover assembly 36 is in a full open state). Each of stub projections 124A and 124B and reception projections 126A and 126B are preferably screw fastened in the respective depressed regions defining the rear region of front cover section 36 and the forward region of rear cover section 76 over which projection panel 98 extends and in which it is received. This provides for insertion of the posts of one into the reception portion of the other and then fastening into fixed position on the cover assembly 36 with fastening means as in screws, bolts and nuts, rivets, bent prongs, etc.

With reference to FIGS. 15A to 15I there is shown an example of a cover adjustment sequence method embodiment (e.g., one possible approach) for adjusting cover assembly 36 relative to a stationary shell main body 23 from a full closed (e.g., normal cooking operation mode) to a full open state (e.g., food withdrawal mode). FIG. 15A shows a full closed state wherein there is provided a sealing relationship between the peripheral edges of the relative first and second cover sections 54 and 76 and the peripheral rim 44, as seen to some extent in FIG. 45. FIG. 15A also shows cover assembly 36 in the full closed state which represents a normal cooking mode state. As seen, front cover section 54 can be considered as representing a first link L1 having a free end and an opposite pivot point end representing first pivot connection P1 represented by the above described “first” hinge connection provided by hinge device 95 which pivotally connects the rear end of the front cover section 54 to the front end of the rear cover section 76 (shown as a second link L2). The opposite end of the link L2 is shown pivotally connected at pivot point P2 to support S2 of shell main body 23. The end pivot point connection P2 is represented by base hinge device 112 and represent a “second” hinge connection.

For example, when cover assembly 36 is in its closed state (e.g., a generally flush and also preferably sealed relationship between the cover assembly and shell main body 23 relative to the peripheral regions of each), the cover assembly 36 is supported by the upper portion of shell main body (with the front and rear support sections of the shell main body shown schematically by the noted S1 and S2). For reference, this closed state can be considered as time “T0”.

FIG. 15B shows as time “T1” a time within an initiation stage of a cover assembly opening sequence, wherein cover assembly 36 starts to lift off from shell main body 23 (e.g., a lift angle in the whole cover assembly (first and second cover parts or sections 54 and 76 still generally coplanar) as represented by angle A1 between link L2 and a horizontal plane H lying flush on an uppermost end of support S2). In this embodiment there is seen that during the initial lift off period (e.g., a rotation of less than 45 degrees) there is retained a straight linkage arrangement or generally straight linkage arrangement (e.g., within 10° degrees of a 180° straight linkage line) with time point T1 being a point within that initial lift off period. It is noted that while reference to FIGS. 15A to 15I are described as an opening sequence, a return sequence can be the same; and thus FIGS. 15IG to 15A can represent a reverse sequence going from a full open to a closed state (with suitable reorientation of the rotation direction angles). The adjustment is preferably carried out by an operator grasping a peripheral region of the cover assembly as in a gripping portion provided in the below described venting corner extension 62 with outer apertured handle region 64 of the front cover section 54. Thus upon initially grasping and lifting front cover section 54 (link L1), rear cover section 76 (link L2) is also lifted up and pivoted relative to point P2.

FIG. 15C illustrates an example of a further rotation of each of links L1 and L2 while in straight line linkage arrangement with the time point noted as T2, wherein the cover assembly is still in a straight line or generally straight line orientation and at angle A2. For example, an angle of 45° or close to 45° as in 30 to 60°. As seen also from a comparison of FIGS. 15B and 15C the straight line cover assembly is continuously being moved from a partially open position to a more open position. As seen in FIG. 15C, pivot P1 has yet to be activated.

FIG. 15D illustrates time point T3 which is at a time point that is later than T2 and wherein first cover section 54, represented by link L1, and second cover section 76, represented by L2 is at Angle A3 are approaching a 90° pivot state (e.g., angle A3 is at 80° which is pre-90° and pre-overcenter). Both links L1 and L2 remain in a generally straight line orientation at time point T3 in this embodiment.

FIG. 15E illustrates time point T4 which is at a time point that is later than T3 and wherein first cover section 54, represented by link L1, and second cover section 76, represented by L2 are at a full open state (see the discussion above regarding the rearward rotation stoppage point in the cover assembly relative to hinge device 95) which is an over-center location that is preferably from 95 to 140°, and more preferably from 105° to 130° as in from 110° to 120° when in its full open stop position. Also, at time T4 representing the initial full open stop position, both links L1 and L2 remain in a generally straight line orientation at time point T4 in this embodiment. Accordingly from time point T0 to time point T4 the cover assembly is shown as having been rotated (clockwise in the views shown) from its closed or cooking state to a full open rotation state but not yet collapsed state. That is, the links L1 and L2 remain generally planar or at a generally 180° orientation as represented by angle B1 in FIG. 15E.

FIG. 15F illustrates time point T5 which is at a time point that is later than T4 and wherein second cover section 76, represented by L2 remains at a full open rotation state, while first cover section 54, represented by link L1, has initiated its collapsing rotation wherein it goes from its generally planar orientation to one wherein its “in cooking state” undersurface U1 is rotated toward the “in cooking state” undersurface U2 for cover assembly 36. In FIG. 15F the link L1 is shown as having been rotated about pivot point P1 (counter-clockwise in this embodiment) from angle B1 to angle B2, with angle B2 shows as being obtuse and less than 180° as in from 145 to 165°.

FIG. 15G illustrates time point T6 which is at a time point that is later than T5 and wherein second cover section 76, represented by L2 remains at a full open rotation state, while first cover section 54, represented by link L1, is further rotated in a collapsing direction. As seen undersurface U1 is rotated toward undersurface U2 and, projection 98 is released or further released from contact with the upper cover section 54. Thus, in FIG. 15G the link L1 is shown as having been rotated about pivot point P1 (still counter-clockwise in this embodiment) from angle B2 to angle B3, with angle B3 being, for example, an angle of 130°.

FIG. 15H illustrates time point T7 which is at a time point that is later than T6 and wherein second cover section 76, represented by L2 remains at a full open rotation state, while first cover section 54, represented by link L1, is further rotated in a collapsing direction. As seen in FIG. 15G, this collapsing or bringing together of the undersurfaces U1 and U2 of the respective first and second cover sections results in movement from an obtuse angle to an acute angle represented by B5 (as in 70°) between the respective links L1 and L2.

FIG. 15I illustrates time point T8 which is at a time point that is later than T7 and wherein second cover section 76, represented by L2 remains at a full open rotation state, while first cover section 54, represented by link L1, is further rotated into a complete collapse state or cooking pot removal state via further rotation of the underside U1 of link L1 to the underside of U2 of link L2. This collapsing or bringing together of the undersurfaces U1 and U2 of the respective first and second cover sections results in movement from an obtuse angle to an acute angle and then to even a smaller acute angle. For example, the rotation of link L1 is preferably carried out until links L1 and L2 assume a completely collapsed state (wherein, for example, the undersides of the respective covers are placed in contact or in a relatively close to contact juxtaposed relationship (e.g., within 15° of separation or more preferably within 8° as in less than 5° (e.g., 0° or contact to 3°) of rotation separation as represented by angle B5. Thus, as shown in FIG. 15I the cover assembly is in a collapsed or minimized outward extension state and in an over-center location. Also the most forward point MF of cover assembly in the fully collapsed state represented in FIG. 15I is shown at or rearward of the rearward positioned exterior surface for the upper edge of cooking pot 140 which is represented by reference line IE in FIG. 15I and represents a rearwardmost location of a food holder support location when pulled essentially straight up out of the cooking pot. Thus, despite the cover assembly being collapsed and just out of the way, the food holder can be readily removed free of contact with the cover assembly. Also, the cover assembly is positioned for ready closure by following the reverse sequence of 15I to 15A, for example, again using the same corner gripping location as described herein.

Different sequences of opening and closing cover assembly 36 is also a feature of the present invention. In other words, there can be implemented, for example, a variation in the stages of cover lift off while in a generally straight line (with rotation about point P2) and/or collapsing (with rotation about P1). For example, in one embodiment there is implemented a collapsing adjustment of the first cover starting at any point along the travel of the link L2.

Also, regardless of the positioning sequence of link L1, the link L2 is preferably rotated the full amount as possible to an “over the center” full open state as that position in described and shown in FIG. 15I.

FIG. 16 further illustrates hinge means 95 that is designed to enable the flush or nearly flush arrangement for the collapsed cover sections arrangement featured in FIG. 15I which includes the above noted pivot post and pivot post reception combination 96A,98A and 98A,98B which make up first hinge apparatus 96 and second hinge apparatus 98 arranged (e.g., extending out toward each other) as to enable the interior surfaces U1 and U2 of the cover assembly 36 to achieve the collapsed state.

With reference to FIG. 8 and FIGS. 16 to 19 and 45, there is described shell perimeter ridge 44B extending radially inward from peripheral outer annular rim flange 44A and radially outward from the inner flange 44C as shown in FIG. 45. As seen, perimeter ridge 44B has a generally horizontal annular configuration with its peripheral outer and inner edges integrated (e.g., fastened or formed as a single, monolithic body) with the respective inner and outer flanges 44C and 44A. In the embodiment illustrated, the combination of perimeter ridge 44B and the inner and outer rim flange 44A and 44C define cap structure 136 which is supported by upper edging of preferably all of the wall panels 24A to 24D as well as the corner cut wall 24E. Also, the outer upper edging surface of the wall panels 24A to 24E preferably are in contact with the interior lower surface of the outer flange 44A and extend up into the corner region defined between flange 44A and perimeter ridge 44B. The upper edge of the interior flange 44C extends up into a well shown in FIG. 45 represented by the concavity defined by outwardly curved flange 138 of the cooking pot 140. Hence, flange 44C is preferably provided with a common peripheral configuration as that of the capture flange or support edging 138 of the cooking pot. Further, as shown in FIG. 28, interior 44C flange preferably comprises an annular, vertically oriented strip of material that is clipped and received in position by way of a plurality of clips 44D extending out and up from the inner edge of ridge 44B.

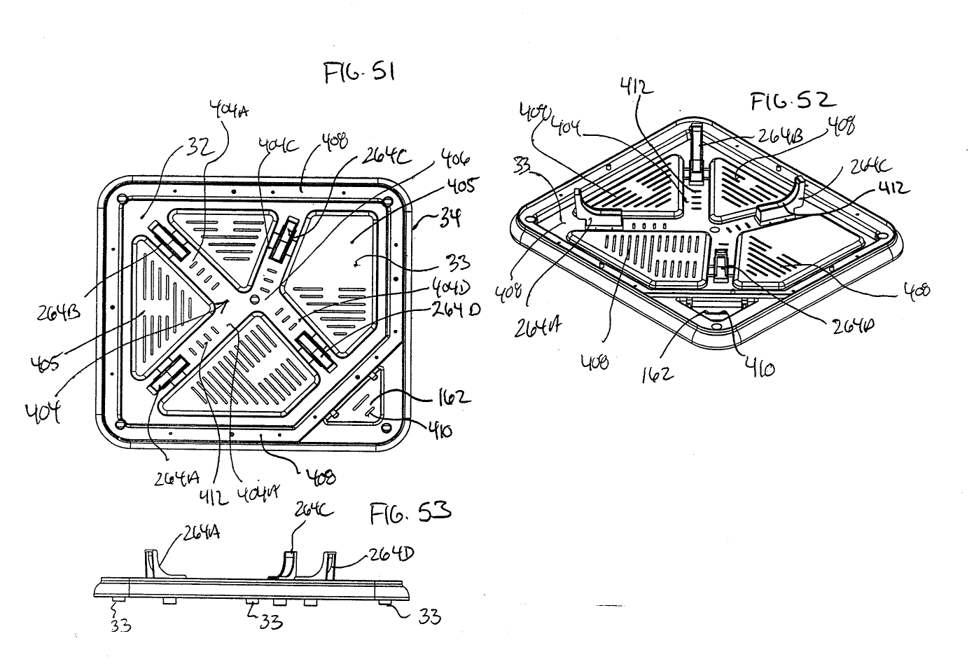

Perimeter ridge 44B also is shown as comprising one or more indentation(s) 144 provided in the exposed surface 146 of ridge 44B, with the illustrated embodiment featuring three corner indentations 144A to 144C (e.g., provided at the three corners which are free of heating device 150 (e.g., not the corner that the heating device extends over) as well as a catch indentation 144D. Indentation 144D provides a reception cavity for a portion of grasping hook 152 (FIG. 18) associated with food support means 154 such as the embodiment shown in FIG. 18 as a food basket 154 with bailing catch 156 and the food holder 154 embodiment shown in FIG. 54. Indentations 144A to 144C represent reservoirs for condensation or “condensation reservoirs” and also preferably extend all the way to ring or flange 44C as to provide a convenient location to receive, when cooled, condensation.

As shown in FIG. 18, indentations 144A to 114C have a gradually sloping radial outer wall that leads to a recessed platform that, in turn, leads to steeper or less sloping (e.g., vertical) wall section represented by the radial outer surface of interior flange 44C. Thus, the indentations 144A to 144D provide finger insert locations to facilitate the grasping of the cooking pot flange 148 when the removal or replacement of the cooking pot is desired. This cooking pot grasping function is thus provided in addition to the providing of condensation recesses at strategic locations (e.g., adjacent the interior surface of the contact edge region of the cover assembly 36).

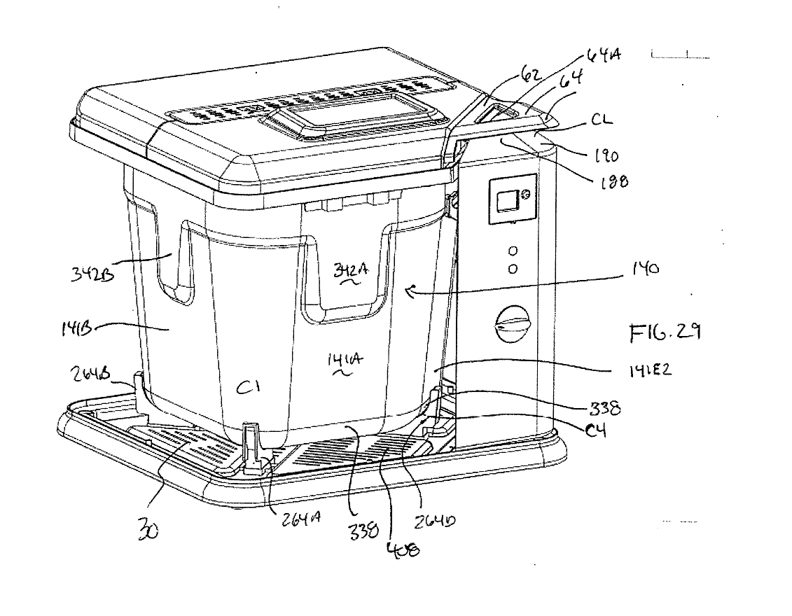

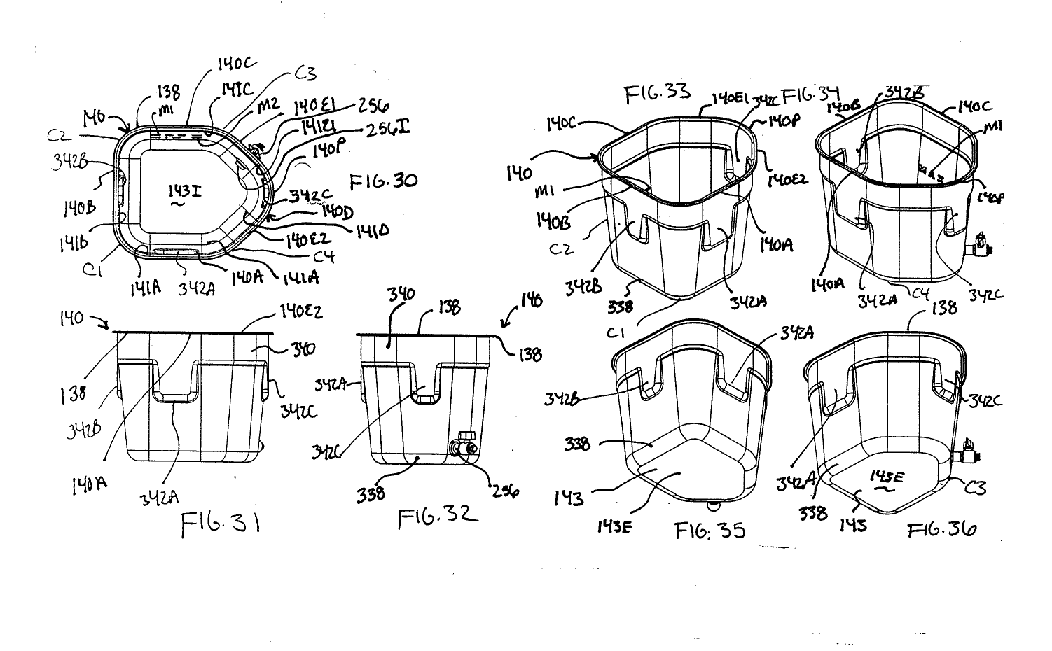

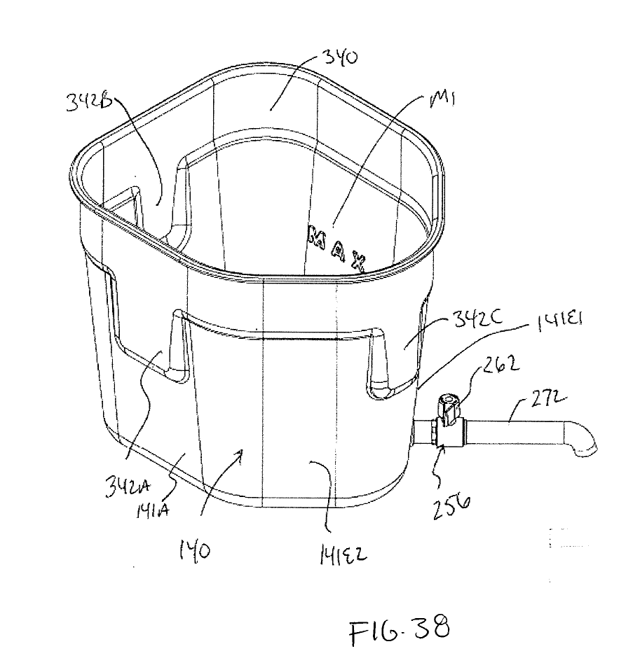

With reference to FIG. 16 and FIGS. 30 to 42 there is provided a discussion of an embodiment of cooking pot 140. As seen from the plan view of cooking pot 140 in FIGS. 16 and 30, cooking pot 140 features a non-symmetrical configuration having a first generally linear edge section 140A that generally conforms to a first (front) side wall section 141A extending generally vertically (preferably tapering inwardly in going from top to bottom). That is, wall 141A preferably slopes inwardly in going from upper flanged section 138 down to cooking pot base or floor 143. In the illustrated embodiment, first generally linear edge section 140A has an intermediate linear section that extends essentially parallel with front wall 24A of the shell main body 23. Also in the embodiment shown, the end regions of section 140A are curved to provide smooth rounded corners. A similar relationship is found relative to each of (i) second generally linear edge section 140B (left side), second pot side wall 141B and shell side wall 24B; (ii) and third generally linear edge section 140C (rear), third pot side wall 141C and shell side wall 24C. The fourth side edge section 140D wall of cooking pot 140 is shown having a roof like configuration with two linear extensions or walls 140E1 and 140E2 leading to a rounded peak (convex projection peak) 140P.

As further seen from FIG. 16, linear extension 140E1 extends generally parallel with the interior wall of heater control unit support structure 26. The linear extension 140E1 represents the upper edge of cooking pot side wall section 141E1 and there is seen in FIG. 16 the vertical heater sections 158A and 158B of heating device 66.

As seen from FIGS. 30 to 36 cooking pot 140 features cooking pot base or floor 143 shown as having a planar interior surface 143I and a planar exterior surface 143E. Further between the respective side walls and the floor 143 there is shown convex in cross-section border regions 338 that bridge the respective outer edge regions of base 143 with the respective bottom wall region for each of walls 141A to 141D.

In the embodiment shown the walls 141A to 141D each taper divergently outward in going from the border region 338 to the upper flanged perimeter 138. It is noted, that for the purpose of cooking fluid volume reduction, only the interior surface of each of walls 141A to 141D need be tapered in the noted manner, although for a preferred embodiment the interior and exterior surfaces feature a common taper.

An embodiment features a taper on each of the noted wall sections as in one that provides for a preset maximum fill line location (the maximum designed for use with larger food items as in a whole turkey) around the 40% to 50% (e.g., about 45%) in total cooking pot height with 0% at the bottom location, and a preset minimum fill line that is in the intermediate region between the cooking pot base and the maximum fill line as in a 20 to 30% (e.g., about 24%) location (the minimum line designed for use with food items not as large as a whole turkey in the 12 lb. or larger range). These maximum and minimum preferred preset locations are designated by indicia M1 and M2 (e.g., line stampings with our without word designations) on the pot. The illustrated embodiment features indicia M1 and M2 as stamped “max” and “min” indicia as well as a fill line that extends horizontally. Also in one embodiment the preset maximum fill line represents a 2 gallon cooking fluid level and the minimum preset level indicia representing a 1 gallon cooking fluid level. The total volume of the cooking pot is preferably in a range of 4 to 5 gallons with an illustrative embodiment volume being about 4.8 gallons such that the 2 gallons represents about 35% to 45% of the total cooking pot volume, with an illustrative embodiment being about 42%.

Also, the minimum line is preferably within 3 inches of the central outlet axis for a drain spigot or outlet aperture provided at the base of the cooking pot (e.g., a 5 to 10% height location). For example, with reference to FIGS. 30 and 32 there is seen spigot 256 with interior extension 256I and an exterior portion 256E extending to opposite sides of the receiving cooking pot wall 141E1.

An embodiment of the invention includes a cooking pot that has a coated surface or laminate as in a metal cooking pot with a porcelain outer coating on the interior surface and preferably generally over the entire exposed surface of the cooking pot.

Also, an embodiment of the cooking pot includes an upper (main body) pot rim region 340 extending vertically down from the curved upper peripheral rim or flanged perimeter 138 of the cooking pot for preferably about 25% of the overall height of the cooking pot (e.g., 25+/−5%) with an example being a cooking pot having about a 11¼ inch depth and a continuous annular upper pot rim region that extends from the upper edge down for 2¾ inches. Also, pot rim region 340 is shown as having less of a diverging taper (e.g., no taper or true vertical or a less than 3° taper) than the remainder of the corresponding side wall or side wall section of the cooking pot. Also below the annular pot rim region 340 there is shown strategically positioned non-or less tapered cooking pot reception recesses or bump outs 342A, 342B and 342C (e.g., small wall segments in the side walls or side wall sections having no or less taper than wall portions both to opposite sides at the same level as well as below the lower edge of the wall segments). This “bump-out” relationship can be achieved by continuing the annular rim configuration 340 down below the lower edge pot rim region 340 but only for smaller peripheral extensions that are preferably centered relative to the respective wall of the cooking pot in which the bump-puts are provided.

The vertical extension of bump outs 342A, 342B and 342C is in an embodiment set at about 25 to 35% farther downward from the lower edge of the annular pot rim region 340 or down to about the ½ way point in vertical height of the cooking pot (e.g., a bump out depth of 3¼ inch down below the lower edge of the annular pot rim region 340 relative to a pot depth of 11 ¼ inches).

Wall segments or bump-outs 342A, 342B and 342C define cooking pot reception recesses with wall segment 342C being aligned with the curved peak 140P of the roof wall portion roof of cooking pot 140 as to extend for ½ to 2 inches to each side of a center of peak 140 (e.g., a peripheral length of 2 inches such that the bump out extends 1 inch to either side of that central line as in for about a 7 inch peripheral length for each of walls 141E1 and 141E2 in which the bump out 342C is formed). Bump out 342B is shown as being formed in wall 141B and being diametrically opposed to bump out 342C. Bump out 342A defines an addition pot reception recess that is shown placed on side wall 141A as to be 90° offset from the above noted reception recesses 342B and 342C. Bump out 342A is also shown as being radially aligned with capture hook reception recess or indent 144D (FIG. 17) in the peripheral rim 144 and as well with the capture hook assembly of the food holder described below.

Wall segment recesses or bump outs 342B and 342C are preferably of about the same peripheral width and are provided as to receive therein (preferably in a non-contact with the cooking pot relationship) opposite bailer handle pivot extension segments (e.g., curved rod extensions at pivot points for a bailing handle for a food holder basket or food capture rack). Wall segment recess 342A is preferably made of a longer peripheral length as that of recesses 342B and 342C as in a 3½ inch peripheral width in front wall 141A of about 7 inches (preferably a symmetrical distance with rear wall 141C) and about a 13 inch “diametric” point to point extension at the upper edge of the cooking pot between a central point of each of wall segments 342B and 342C. An embodiment features the tapered in bottom surface of the cooking pot 143, relative to the same direction as the diametric extension above, as having about a 10 inch peripheral extension at the base 143. Also the tapering in the illustrated embodiment provides for a cooking pot width lessening as in a cooking pot width (upper, internal edge of front wall 141A to upper, internal edge of rear wall 141C) of about 10½ inches down to about an 8 inch width along the plane of interior base surface 143I. Also, the central axis of spigot receiving aperture 256A formed in the cooking pot is preferably at or less than 15% of the height with less than 10% preferred (e.g., 9% as would be provided with a spigot outlet axis 1 inch up from the base for a 11¼ inch depth pot).

Also as seen by FIGS. 41 and 42 base wall 141B and the diametrically opposed wall 141D (comprised of curved peak wall section 141P and sloped roof wall sections 141E1 and 141E2) each preferably have a taper as in a taper of AT1 and AT2, respectively, with each of tapers AT1 and AT2 preferably being in a range of 2.5 to 8° as in about a 5.5°. Also taper AT1 is preferably equal to AT2 (e.g., each with a 5.5° taper). FIG. 42 further shows front wall 141A with a taper AT3 which is also preferably in a range of 2.5 to 8° as in about a 5.5°. Also, taper AT3 is preferably equal to AT1 (and AT2). Rear wall 141C is preferably designed to be symmetrical to front wall 141A and thus also preferably has a taper value having the taper characteristics described above for wall 141A

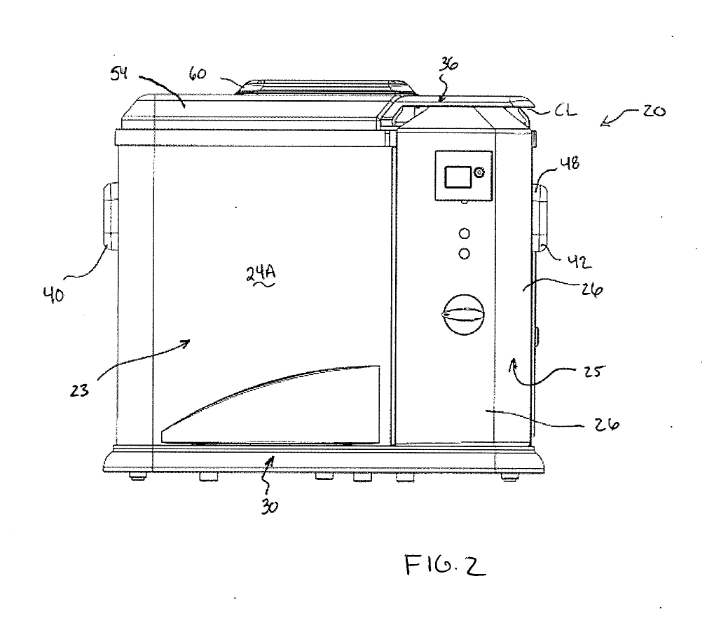

With reference to FIGS. 2, 8, 8A and 17 to 20 and exploded FIG. 28 there is described in greater detail controllable heating assembly 25 which comprises heater support structure 26 and heating device 66 in combination. As seen, controllable heating assembly 25 features a heater support structure 26 in the form of a heating unit support tower with a tower base portion 160 received within the corner confines of the associated reception corner 162 provided in shell assembly base 30 at base portion 160.

In an embodiment there is provided releasable engagement means 340 between heating unit support tower 26 and shell base 30. This includes, for example, a male projection and female reception friction lock such as that represented in FIGS. 8 and 8A by polygonal projection (e.g., triangular configured) 342 designed for receipt by the correspondingly shaped recess 344 at reception corner 162 of shell assembly base 30. This includes, for example, a triangular bump-down region 346 formed as to extend below the main floor surface 348 of base 30 at corner region 162 of base 30 as shown in FIG. 7. Also, with reference to FIG. 8 there is seen sliding engagement plate 350 having reception grooves 352 and 354 designed to receive in locking fashion electrical contact prongs in similar fashion to the arrangement described in U.S. Publication No. 2009/0087534. The engagement means 240 thus can be implemented in conjunction with a simultaneous electrical contact assembly between support structure 26 and plate 350.

Further shown in FIGS. 8 and 8A is power supply interface 164 which, in the illustrated embodiment, includes a recessed plug receptacle 166 with connection prongs 168 and 170 for engagement with power cord 338 (FIG. 28).

A suitable electrical cord or alternate power supply line means 338 provides power to the electronics contained in control unit shell section 26 that are used to adjust the heating element heat input being provided directly to the cooking fluid as in the manner described in the aforementioned U.S. Pat. No. 7,412,922 which is incorporated herein by reference in its entirety. This includes, for example, feedback input from the sensors 170 and 172 (FIG. 16) mounted on support member 174 provided in the region at the base section 176 of heating device 66 and, in the illustrated embodiment, supporting both sensors 170, 172, base heating device section 176. Support member 174 can also provide direct support contact to the bottom of a food support means such as the below described basket 154 (FIG. 17) and rack assembly 450 or, the food support means can have its own legs or support extension means as to suspend the bottom of the good holder means above support member 174. Sensors 170 and 172 are preferably provided the for use in adjusting the output of the heating device either higher or lower to achieve a desired preset temperature and a fail safe sensor to shut the system down if cooking fluid reaches a preset high end temperature.

Further featured is adjustment device 178, as in a temperature and/or timing adjustment dial (or alternate adjustment means such as a keyboard or slide switch or alternate input device) as to set a preferred temperature of cooking fluid setting and/or preferred cooking time. In the embodiment shown in FIG. 9, for example, adjustment device 178 is a turn dial used to set a desired cooking fluid heating temperature based on a temperature range of, for example, 0 to 375° F. (or 190° C.) with a suitable temperature indicator preferably circumferentially spaced about the dial as in 50° increments (not shown). There is further shown in FIG. 9 display unit 180 which conveys information as in current temperature and/or current cooking time remaining, etc. Display means 180 can be powered by the same electrical cord 338 or can be a self contained unit with its own power source as in a battery power. There is also preferably featured with unit 180 a reset/set button 182 (e.g., time setting button). Also, there is preferably provided an on/off power signal light 183 and a temperature “ready” light 185 shown adjacent the display unit 180 in FIG. 9, for example. Also preferably provided is one or more alternate display devices as in power on or temperature low display devices such as signal lights or the like, with reference number 184 being representative.

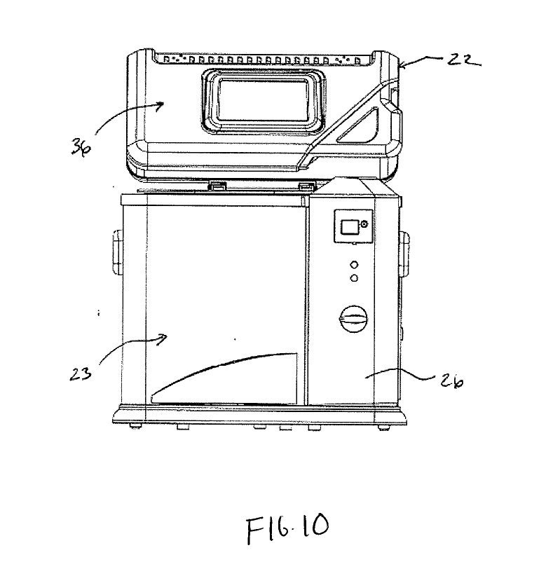

As seen from FIGS. 9, 12 and 17, for example, heating assembly 25 features heater support structure 26 in the form of a heating unit support tower (or “tower” for short relative to this embodiment). The tower features an upper region 186 which comprises cap 188. As shown, cap 188 is designed as an integrated cover over the controls and redirection section 167 of heating device 66 by covering over the top of the tower 26. This way only the radial extension portions 190A and 190B of redirection section 167 (which respectively lead into the vertical sections 158A and 158B (see also FIG. 44) of heating device 66) are exposed in the region of the control tower. Cap 188 is further preferably designed to lie directly under (with a slight clearance) extension section 62 of shell cover assembly 36 as by way of tapered or sloping edge wall(s) 190. Thus, in a preferred embodiment the upper end of cap 188 is directly below tapered flange rim 64 when cover assembly 36 is closed, but there is provided a clearance gap at an outer edge which facilitates finger (or finger in mit) grasping.

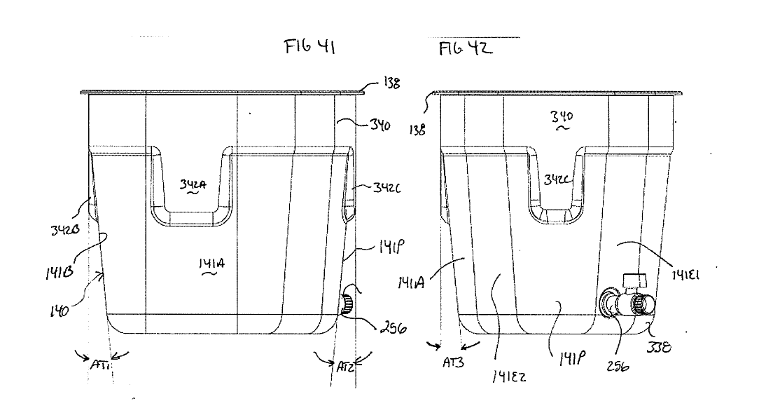

With reference to FIGS. 29 and 46 there is seen the overhang of extension section 62 relative to the cap end 188 with tapered upper region 190 of the support structure 26. The tapered upper region 190 provides a hand grasp clearance location CL at the corner extremity which provides for initial finger grasping of cover assembly 36 and initial lifting manipulation.

Also, with reference to FIG. 15B, which shows the initial lifting of cover assembly 36 from control unit support structure 26, there can be seen that the region 56I of first cover panel 54 representing the cut-corner portion of the tapered region 56 of cover assembly 36 is not uninterrupted as in the other tapered region such as 56A. Rather, there is provided accommodation means 350 which includes bridge 336 with bridge base sections 353 and 354 to opposite sides of a heater element reception aperture 356. Further, to avoid an undesirable extent of vapor or steam seepage around the extension region of the heating device 66 and the reception aperture 356, the area is covered over with seal device 358 which is flexible and preferably also of an insulative material (e.g., silicone rubber). Also, seal device 358 is preferably provided with slotting (e.g., a pair of slots) opening out at the bottom edge of seal device to accommodate heater element extension 192A and 192B upon closure of cover part 54 (and to allow for separation of the seal from heater portions 190A and 190B received therein). Despite this seal device their can be expected some steam seepage which aperture 62A (FIG. 1) is well designed to channel in dissipating fashion away from the hand grasp outer region of flange extension 62.

As seen from the embodiment shown in FIGS. 8, 8A, 19 and 20, the illustrated tower 26 is an independent unit that has tower base 160 received within the above noted associated reception corner 162 of base 30. As shown in FIG. 8, interior shell wall 24E of shell main body 23 (e.g., a corner cut off wall for shell body 23) is provided and in an embodiment with walls 24A to 24E that are formed by bending a single sheet of material and then joining at the contacting edge positioned between wall sections 24E1 and 24E2. The face plate 350 also can provide a position retention function at that wall section interface. Further, shell wall 24E is shown with a section of vertically extending flange 44C in similar fashion to the other walls 24A to 24D above described.

FIG. 16 further illustrates that heating device 66 includes a base heating element section 194 (or heating element loop in the illustrated embodiment) which is supported in suspended fashion above the base 143 of cooking pot 140 by support member 174 and has end portions 196 and 198 joined (e.g., monolithic continuous resistance type heating element or connected portions) at interface 200 with the lower end of vertical portions 192A and 192B. Loop 194 is generally similar in shape to the horseshoe configured heating element described in the aforementioned U.S. Pat. No. 7,412,922, but includes a modified configuration that includes an off-centered location for interface 200 which is provided for by an unsymmetrical configuration that is achieved by way of bridging heating device section 202 featuring first and second extension segments 204 and 206 that extend from an exterior resistance heater rear side edge 208 to an exterior resistance heater front side edge 210. The off centered or non-symmetrical heater device design positions the loop's interface 200 in juxtaposed position (e.g., at the base of the pot side wall section 141E1) such that it is just radially inward of the corner portion of the shell assembly which supports tower 26. As shown, first and second bridging extension sections 204 and 206 are arranged in an obtuse angle configuration with an intermediate curved region provided between those two linear sections.

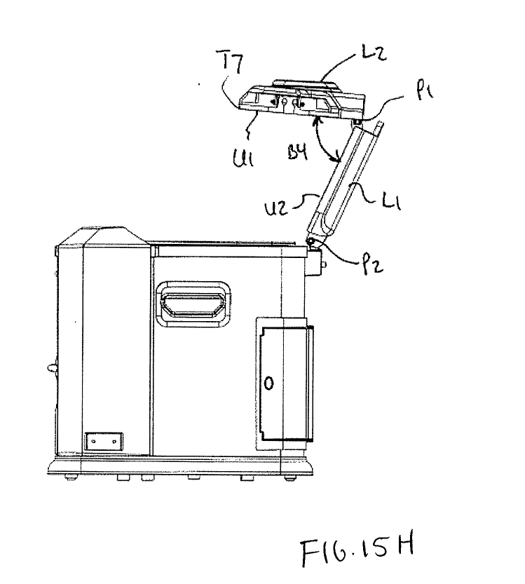

With reference to FIGS. 20, 21 and 28, for example, there is provided a discussion of a first embodiment of food holding means 154 which is shown in this embodiment to be a basket device. As seen in these Figures, there is included grasping device 152 which is shown in this embodiment as a grasping hook such as that described in U.S. Pat. No. 6,711,992 to John Mclemore, which patent is incorporated herein by reference, but with some additional modifications as described below. Also, basket 154 preferably features apertures formed in the base and sides of basket 154 with a suitable aperture solid wall basket arrangement being such as those described in the above-referenced U.S. Pat. No. 6,711,992.

FIG. 17 shows basket 154 in its lowermost setting (e.g., with the basket base supported in suspended fashion above the bottom of cooking pot 140 by way of its own suspension legs and/or support member 174) and with the food support grasping member 212 (e.g., a basket bailing handle) having been pivoted from its rest position wherein it is in contact with main body 214 of basket 154 to a more vertical orientation such that it is graspable by grasp device 216 shown as having a handle loop 218 and a pair of spaced apart catch members shown in the form as hook catches 220 and 222, which are further shown as being designed for engagement with a similarly spaced apart pair of grasp cavities formed by grasp projections 224 and 226 of the upper portion 213 of grasping member 212. In the illustrated embodiment, the catch members 220 and 222 are represented by a “Y” shaped extension with hook loops at its free ends and with the base of the Y-shaped extension being at an intermediate, lower location relative to the upper loop or hand grasping portion 218 of grasp device 216.

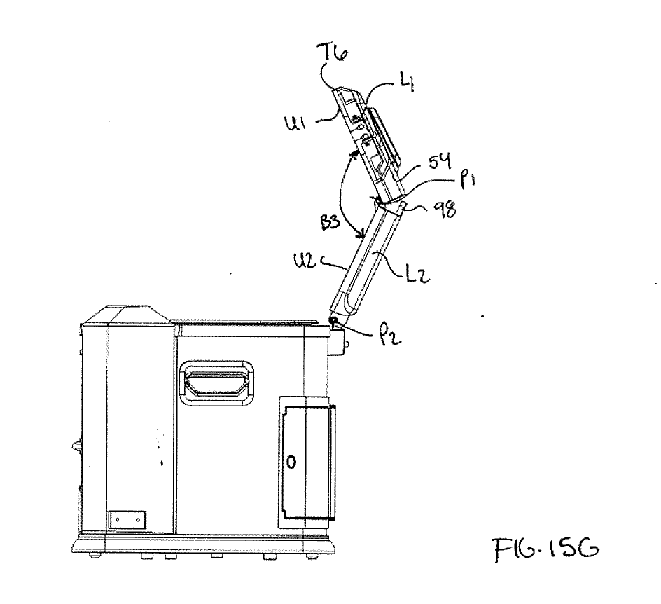

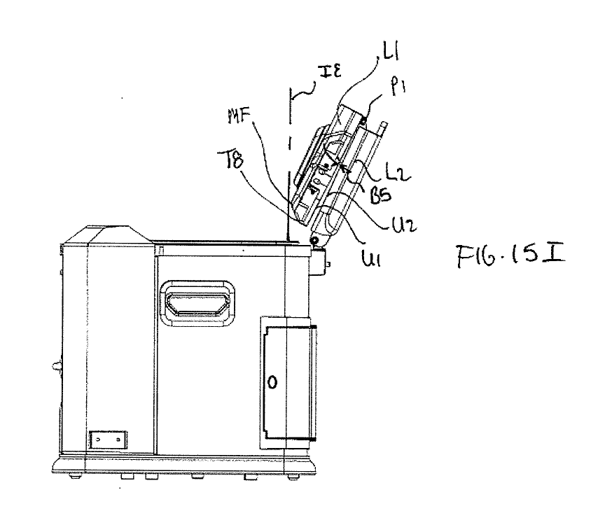

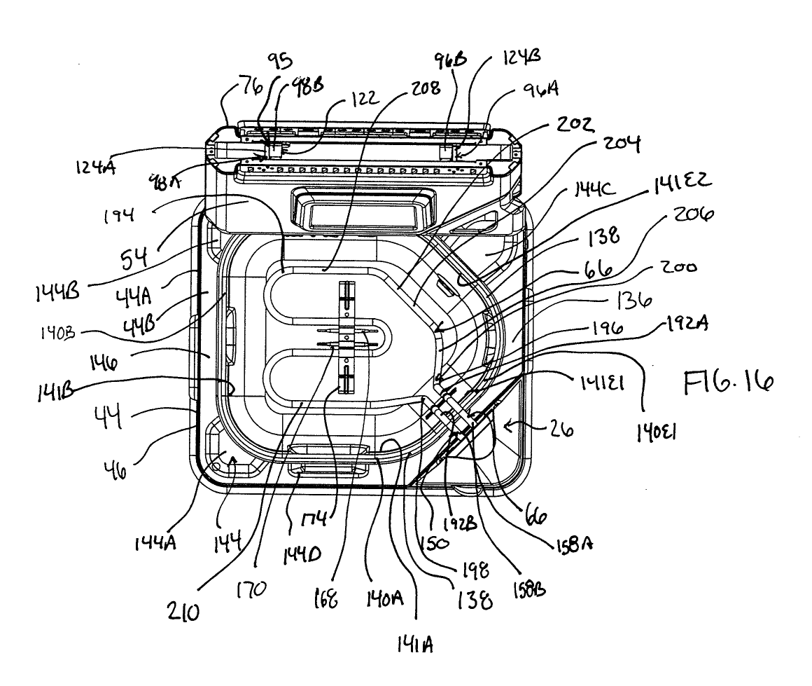

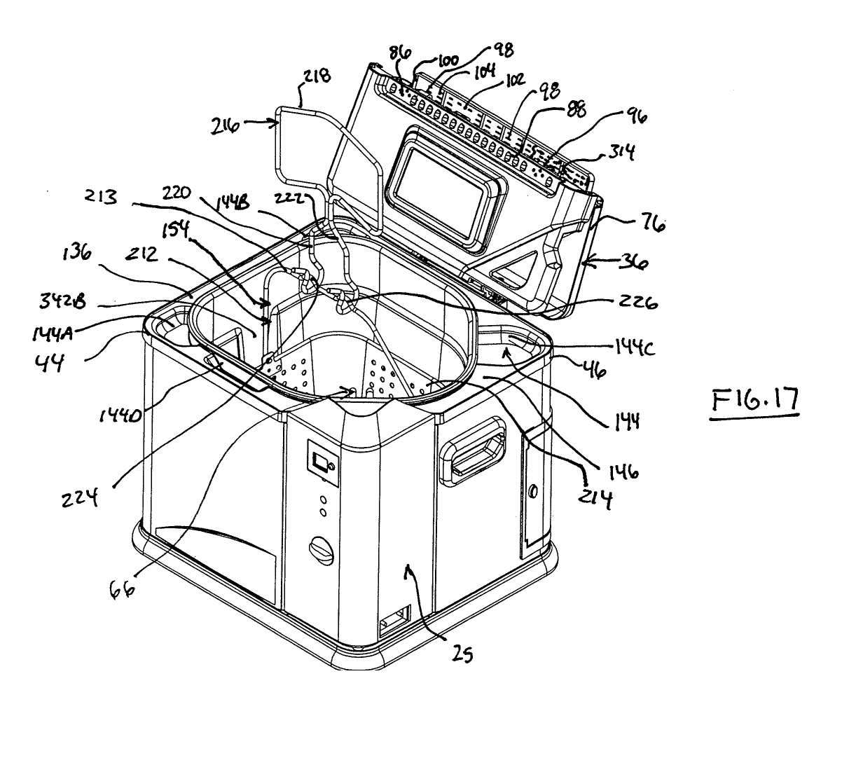

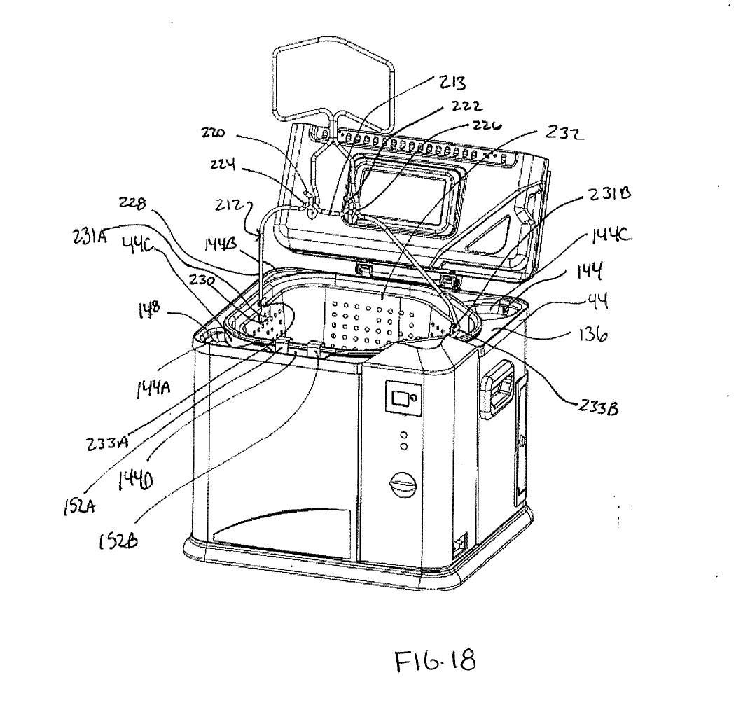

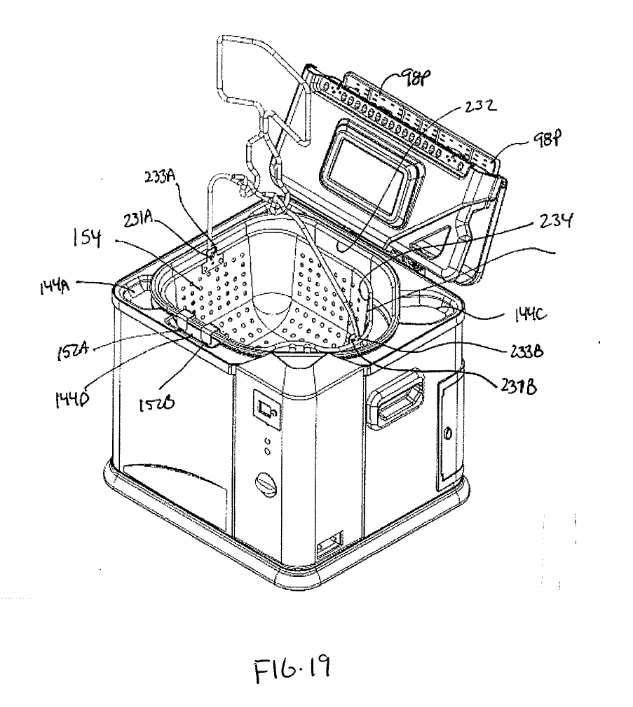

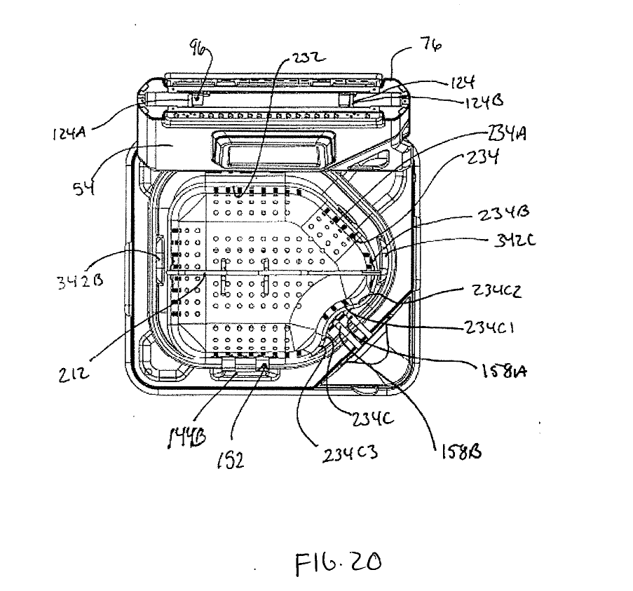

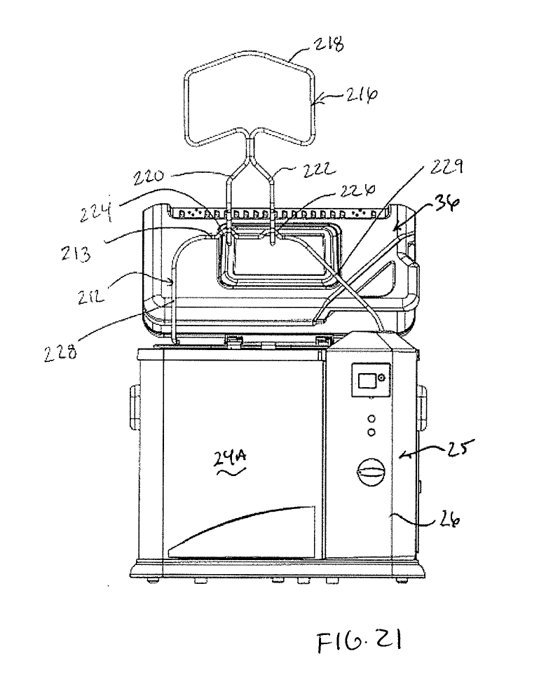

With reference to FIGS. 19-21 there is further seen that grasping member or bailing handle 212 has an unsymmetrical configuration with a more steeply rising first rise section 228 (left end in the noted FIG. 21) that is pivotally joined at its free looped end 233A to first (left) side wall section 230 of basket 154 (which side wall is that which is closest to cooking pot edge 140B) via a T-shaped adaptor 231A extending up from the main basket wall. Also, first rise section 228 has an opposite end joined to a first end of upper portion 213 of handle 212. The opposite end of intermediate portion 213 is joined with a second rise section 229 which has a less steep slope and is thus longer in length than the first rise section 228 in extending down from the intermediate portion 213 to a similar height pivot connection in the opposite (right-third) food holding means side wall section 234 which is shown as having an overall curvature generally conforming to that of side wall 140P of cooking pot (but with a deviation in the relative matching curving relationship as described below). This opposite pivot connection is shown in FIG. 18 to be connected to adaptor 231B which has an aperture to receive the looped pivot extension 233B. As further seen in FIGS. 17, 18 and 20 the pivot loop extensions 233A and 233B are in alignment and preferably extend into the interior bump-out recesses of aligned cooking pot bump-outs 342B and 342C. As in a peripherally centered location when the cooking pot is in its generally centered position and with the width of the bump out recesses 342B and 342C preferably being sufficient to maintain the recess reception state even when the basket is moved to a catch or intermediate state with respect to the side of the shell assembly like that in FIG. 18 (see FIG. 20 for the shifted position in plan view).

That is, in FIG. 17 the food holder or food holder means (in the form of a basket in this embodiment) 154 is shown as being in its cooking position wherein it is generally centered or is positioned as to have spacing between the periphery of the cooking pot and the periphery of basket 154 while supported on or above support member 174. This arrangement is further illustrated in cross-section FIG. 43 wherein basket 154 is shown in its cooking mode position shown generally centered relative to the interior walls of cooking pot 140.

This generally centered location at the tapered-in bottom region of cooking pot 140 on or above support member 174 provides for a periphery non-contact cooking mode (with the non-contact relationship preferably including a “close-but-no-contact” relationship between capture hook device 152 relative to the two downwardly facing hook extensions 152A and 152B (see FIG. 18) and the lower upwardly facing hook extension or stabilizer projection 152C). As seen from FIG. 44 when the food holder 154 is placed into the catch and drain mode, the upper hook extensions extend across the upper edge of cooking pot 140 to fix in position the basket 140 in a drain mode. Also, the lower positioned extension 152C is shown as contacting the planar surface defined by the interior surface of bump out 342A. As shown in FIG. 19, the free end of hook extensions 152A and 152B also are received in and/or vertically aligned with recess 144D in peripheral rim or ridge 144.

FIGS. 18 to 21 illustrate food holder 154 in a catch or an intermediate state (between a lower cooking state and a removed from shell assembly state) which intermediate state is shown as being a drain state with catch hook 152 providing for the basket's suspension above its normal cooking mode support state which places the basket in contact or slightly extended above (e.g., ½ inch or less) support member 174. The base of the basket 143 is at a higher level from its initial cooking state when in the catch state as in its base being above the cooking fluid level, as in above either or both of the noted maximum and minimum marks M1 and M2, prior to or after some period of drainage as via the spigot release of cooking fluid described below. As seen in FIGS. 18 and 20, basket 154 features a second side wall section (rear elongated wall) 232 that generally conforms in configuration to the corresponding (rear) side wall 141C and side edge 140C of cooking pot 140. Third cooking basket side wall section 234 (which receives in pivoting fashion the elongated end portion of second rise section 229 of bailing handle 212) has a generally similar overall configuration as that of cooking pot side wall 141D (or 141E1, 141P and 141E2) but with the below noted deviation. Side wall 234 features a first (rear) linear wall section 234A, a second, peak curved region 234B wall section followed by a third “reverse S” wall section 234C having a central concavity 234C1 and two convex portions 234C2 and 234C3 to each side thereof. As there is greater clearance spacing with a more central positioned basket or food holder 154 relative to the cooking pot's interior wall structure than one shifted into its drainage position, the concavity 234C1 is provided and, as best shown in FIG. 20, positioned as to extend to essentially equal amounts to opposite sides of first and second vertical sections 158A and 158B of heating device 66 when the basket is in its intermediate state (e.g., when the catch device represented by catch hook 152 in the illustrated embodiment is aligned in the depression or condensation recess 144D in the upper surface of annular rim 44 as in the centralized position shown, the vertical heater sections 158A and 158B are peripherally centralized within the cavity defined by concavity 234C1). In other words, first and second vertical sections 158A and 158B of heater device 150 are generally centrally situated within the concavity 232C1 while the convex portions are preferably in contact or closer in contact relative to the adjacent side wall portions of cooking pot 240 which occurs when the food holder is moved from a cooking mode to the drain mode shown. Thus, as best seen in FIG. 20, both cooking pot 140 and basket 154 have a generally similar “house” configuration with a base wall (left), two parallel side walls (front-back) and a curved roof shape wall (right). Further, the peripheral area of the cooking basket is preferably less than that of the cooking pot to provide radial clearance between the two in the cooking mode. The relative periphery clearance also provides for relative shifting of the basket into an elevated height catch relationship relative to the cooking pot with the basket having an added side wall deviation to accommodate vertically extending heater components of the heater device (e.g., providing for heater device contact avoidance).

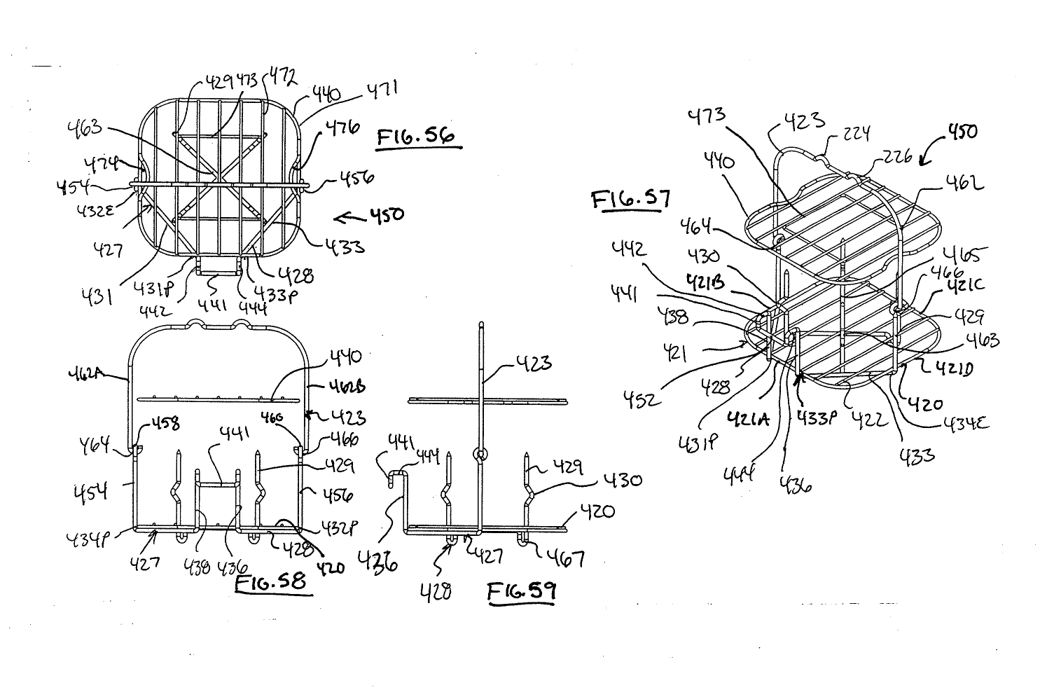

FIG. 18 illustrates grasping member 212 having been engaged by grasp device 216 and lifted and shifted forward from its central pot cooking position (described below) to a hook catch relationship with the forward edge 140A of the cooking pot 140 (preferred location although alternate hook catch and side edge support locations are also featured herein). At this location the basket with food item supported therein (not shown) as in poultry (e.g., a whole turkey), seafood (as in shelled items, fish, shrimp, etc., other meat items such as red meat steak (e.g., rack supported steak), other non-meat items as in vegetables, etc. (food in general) is in a drainage mode which can last for a period that avoids undue drippage as the basked is moved between the shell assembly and the food distribution support location (e.g., a countertop or table location). While basket 154 is featured in the illustrated embodiment various other food holders or food holder means are featured under the present invention. This includes those featured in the aforementioned U.S. Pat. No. 7,412,922 as well as alternate food holder means such as the rack described in U.S. Pat. No. 6,742,446 to the same inventors, which patent is incorporated herein by reference (with, for example, an alternate embodiment as that illustrated with, for example, a more rectangular peripheral configuration for the pronged food holder extension support). In this regard, references is made to the discussion below concerning FIGS. 54 to 59 describing an alternate embodiment food holder means of the present invention.

As further shown in FIGS. 19 and 20, food holder 154 is in the form of a basket which includes a depressed region or step-in 234C1 for receipt of first and second vertical sections 158A and 158B of heater device 66 extending generally vertically down along the interior of the cooking pot, which depressed region 234C1 is positioned as to be in better alignment relative to the heating device 66 when the basket is in a catch relationship relative to the catching means or catch support 219 than when in a cooking position in said cooking pot (e.g., the more centralized positioning of food holder 154 provides a greater tolerance in achieving a preferred (for this embodiment) non-direct contact relationship between heating device 66 and basket 154). Also, an embodiment features a catch support as in catch hook 152 shown comprised of catch members 220 and 222 with the embodiment shown featuring L-shaped hook catches 220 and 222 extending out in cantilever fashion and then down into catch indentation 342A formed in the cooking pot (FIG. 31).

To achieve the above-noted cooking mode to drainage mode in cooking basket 154, grasping member 212 is engaged by grasp device 216 and lifted and shifted forward from its central pot position to its hook catch relationship with the forward edge (preferred location although alternate hook catch and side edge support locations are also featured herein). At this location the basket with food item supported therein (not shown) as in poultry (e.g., a whole turkey), seafood (as in shelled items, fish, shrimp, etc., other meat items such as red meat steak (e.g., rack supported steak), other non-meat items as in vegetables, etc. (food in general) are positioned for cooling and cooking fluid release (with an embodiment of a compact design featuring an initial relationship wherein the basket 154 is elevated from its cooking position but its bottom surface remains below the upper surface of the cooking fluid with that level dropping below the basket base floor following the below-described drainage).

With reference to FIGS. 54 to 59 there is seen an embodiment of cooking apparatus 20 featuring an alternate food holder means 154. As seen in FIG. 54, folder holder means 154 is in the form of a rack device 450 for deep-frying meats, poultry, fish, vegetables (e.g. deep fried onions) or similar sized food products. Rack device 450 includes lower grill 420 with outer rim 421 having a generally square or rectangular configuration made up of front side rim section 421A, left side rim section 421B, rear side rim section 421C and right side rim extension 421D with respective interconnecting rounded corners sections.

Rack device 450 further includes food support rack 427 which comprises base structure 428 and a plurality of prongs 429. Food support rack is shown extending under lower grill 420 and preferably in an attached state therewith (e.g., friction contact attachment or more permanent attachment as by a welding or looped rod engagement). Lower grill 420 has a plurality of crossing supports 422 which, in this embodiment, are shown extending perpendicular with two opposing rim bars and parallel with the other pair of rim bars forming outer rim 421. Crossing supports 422 are preferably made of stiff metal wires or bars and are shown in this embodiment arranged parallel to each other. The outer rim 421 can also be made of a stiff metal wire or bar and can serve to give the lower grill 420 a generally rectangular with rounded corners shape and the ends of the grill bars or wire are welded thereto. The lower grill 420 is preferably free of any interior annular or circular rings other than its outer peripheral ring 421.

The lower grill 420 supports food support rack 427 which has an attach portion or base structure 428 that is preferably attached (e.g., welded) to the crossing supports 422 of the lower grill 420. The food support rack 427 has vertically extending prongs 429 onto which meat, poultry, fish or a similar sized food product can be fastened or skewered onto each prong 429 or one or sets of prongs. Each prong 429 is shown in this embodiment as having a radial protrusion 430 such as the illustrated integral curved bend portion that preferably curves out toward the periphery of the device and which serves to support the below described upper grill 440 when the upper grill 440 is used and slid into position.

Base structure 428 is shown as having center portion 463 extending radially out from which extends a plurality of base extensions or spokes 465 with the illustrated embodiment having 4 spokes arranged at 90 degree intervals as by way of two criss-crossed full diameter extensions (as with an integration at the center as in welded groove reception arrangement—with each or just one recessed) or individual spokes extending out from a common attachment hub (e.g., a welded end point arrangement). Prongs 429 (four shown in the illustrated embodiment—although lesser or more are featured in the present invention as in two or more such as 2 to 12 (e.g., 4 to 8) prongs extending up from a corresponding number of base extensions or a plurality on one or more of the length of the base extension) are shown as extending up from the radial outer end of base extensions 465. Alternate base extension support designs are featured in the present invention as in a spiral or polygonal base configuration free of spokes but providing radially outer (from the center point) prong support bases.

The lower grill 420 and food support rack 427 combination, which is referenced as rack assembly 431, also has a lifting extension assembly 423 which has an end 424 that is attached (e.g., frictionally retained or more permanently attaches as by welding) to the outer rim 421 of the lower grill 420 and/or to base structure 428. Lifting extension assembly 423 allows the user to lower and raise the device through use of a grasp device 216 (FIG. 19) like that described above for the basket embodiment.

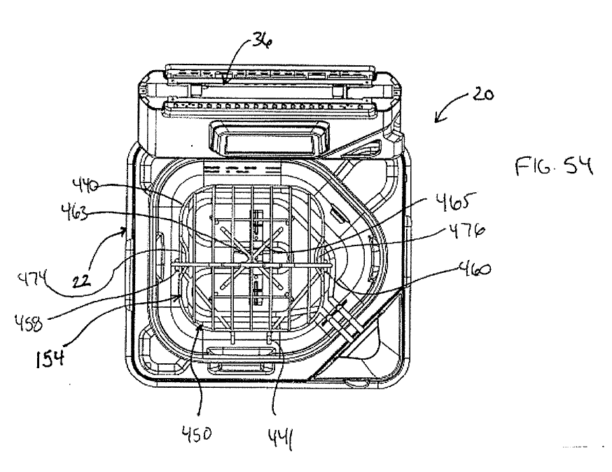

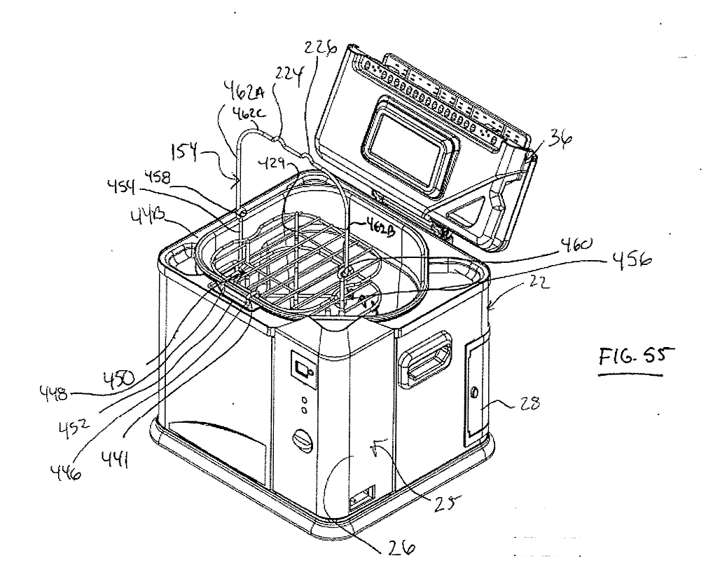

Lifting extension assembly 423 is shown as being positioned and extending radially outward of the peripheral ring lying on the corresponding radial outer ends of extensions 465. Lifting rod assembly 423 is shown as comprising a pair of underlying lifting extensions 431 and 433 that each have an end portion (431P and 433P) in contact with front rim section 421A with the end portions spaced apart an equal amount from a center point of front rim extension as to be in respective intermediate areas formed between that center point and the outer extremities of the rim section 421A. The underlying lifting extensions 431 and 433 are shown in FIG. 56 as diverging from their starting end points 431P and 433P to a respective one of the left and right side rim sections 421B and 421D. As further shown in FIGS. 56 and 57 the opposite ends of the respective lifting extension 432 and 434 extend to an end location 432E and 434E positioned at an intermediate location on the opposite side rim extensions as in at the center location for each of rim extensions 421B and 421D as in the center point of the noted sides.

Extending vertically up from the end region of lifting extensions 431 and 433 (as in directly vertically up from the respective end points 431P and 433P) are catch support members (e.g., bars) 436 and 438. Joined to the upper region of the vertically extending catch support members 436 and 438 is catch extension 441 shown as being an integrated hook extension extending radial out from free ends of catch support members with a hook configuration suited for catch securement to another structure as in the upper edge of the cooking pot 140. The catch extension 441 is shown as having two generally horizontally extending contact members 442 and 444 that are design to extend over and in contact with an underlying support such as the upper rim of the cooking pot in spaced apart fashion. Extending down from each of the generally horizontally extending contact members 442 and 444 is outer catching components 446 and 448 which, in this embodiment, are shown interconnected with bridge extension 452 shown as also being an integral common manipulated bar shape. Catch extension 441 is designed to engage the cooking pot and/or shell assembly in similar fashion as to the catch extension 152 in the above described embodiment. Alternate catch means are also featured under the present invention including a single hook type contact engager as opposed to the peripherally spaced apart contact components 446 and 448.

Extending upward from the respective end regions of lifting extensions 431 and 433 (which end regions are inclusive of end locations 432E and 434E) are lifting members 454 and 456 (e.g., a pair of vertically extending lift bars). At the free end region of each of lifting members 454 and 456 there is shown catch components 458 and 460 which are in the form of closed free end loops (e.g., a curved end of a lift bar that is bent over back toward a lower portion thereof) in the illustrated embodiment. The catch component(s) provide a catch location for a grasping member 462 which is shown in the form of a bailing handle with engaging members 464 and 466 at the respective free ends. As with the above described grasping member 212, grasping member 423 is provided with opposite vertical extensions 462A, 462B (symmetrical in this case) as well as a bridging component 462C with two upper and spaced apart grasp projections 224 and 226 to which the hook portions of the above described grasp device 216 are engaged. Thus the food holder 154 shown in FIGS. 54 to 59 can be raised and lowered as well as shifted along a horizontal plane as when it is desired to place the food holder 154 in a catch state using the above described catch extension 441.

Also, as seen in FIGS. 54 to 59 the interface region between base extensions base extensions or spokes 465 and prongs 429 there is provided downward projections 467, which in the illustrated embodiment are provided by a curved bottom bend projection at the noted interface for at least some and preferably all of prongs 429, which bend projections extend down below the lower plane of the lower grill as to provide bottom pot surface contact means. Projections 467 are, for example, of a length that places the lower grill in a suspended state above the base of the cooking pot (and, in similar fashion, above the base of a countertop or the like). Also, the projection length is preferably designed as to be greater than the support height relationship between the lower support member 174 and the base of the cooking pot, although alternate embodiments include downward projections 467 which are designed to make initial contact coincident with support member 174 contact or to be shorter such that support member 174 provides all of the contact support in and of itself.

An embodiment of the invention includes food holder means with both the lower grill and an additional upper grill 440, with the upper grill having crossing supports 472 and an outer rim 471. The crossing supports 472 can be made of stiff metal wires or rods as described above for lower grill 420 and are preferably parallel to each other across the entire area defined by the outer rim or ring 471 (e.g., common spacing and alignment with lower grill). The spacing is arranged to preclude predetermined certain sized food from falling through (e.g., following slippage from a preferred space relationship relative to the grills) while allowing full cooking medium flow through and thus other arrangements achieving these functions can also be utilized. The outer rim 471 can also be made of a stiff metal wire or bent rod as above and can serve to give the upper grill 440 a generally rounded corner square shape as with the lower grill but with some added peripheral concavities or bump-ins 474 and 476 (radially inward, horizontal projection providing a concavity on the radial outer surface).

The upper grill 440 also has an internal, centrally located ring 473, or some other means of protrusion support contact, which is generally concentrically arranged internal of the outer ring 471. Inner ring 473 is shown as having a generally similar overall configuration as the exterior ring 471 (generally square in this embodiment although other shapes such as circular, or a shape more precisely conforming to the cooking pot interior surface, etc., are featured in the present application). Inner ring 473 is arranged to come in contact with the radial protrusions 430 (curved bend portions in this embodiment) of the prongs 429 extending up from the lower grill. This facilitates proper centering during assembly by directing an offset upper grill 440 radially inward to a center location during assembly. The diameter of ring 473 is such that there is preferably a minor radius tolerance when the upper grill is horizontal (e.g., a frictional slide contact relationship) relative to the prongs above the protrusions to help maintain the upper grill from shifting in use. The upper extremity of prongs 429 are preferably positioned to be generally of a common height as the catch components 458 and 460. Also, the height of catch extension 441 as in the height of the two generally horizontally extending contact members 442 and 444 is preferably below that of the upper extremity of the prongs as well as preferably below the location of the catch components 458 and 460 with an embodiment including a catch component 458 and 450 height in an intermediate region as in about half way between the free end of the prongs and the upper initiation point of the projections or radial protrusions 430. Also the protrusions are preferably in an intermediate position between the prong free end and the lower grill upper surface (e.g., 30 to 70% location up from the grill relative to the full height of 100% to the free end of a prong and about 50% being illustrative).

Also, the concavities 474 and 476 are provided as to be aligned with the two lifting members 454 and 456 upon initial insertion of upper grill 470 in position for reception by the prong projections 430 upon insertion down into position. That is, with the embodiment shown, upper grill 440 can be easily slid into and out of position relative to rack 427 and lower grill 420. It can thus easily be utilized or not during a cooking operation with the type of food pieces (similar or a mix of different types) being typically controlling as to which arrangement (with or without upper grill) is preferable. U.S. Pat. No. 6,742,446 which is incorporated herein provides some illustrations of examples of food types and relative positioning on a rack device which is applicable in the present embodiment. An example being the placement of a plurality of cuts of meat (e.g. four steaks—not shown) that are provided on each of the prongs vertically upper of the upper grill and with some being held in position with the prongs between the upper and lower grills.

In an embodiment, cuts of meat are sized such that each cut has two prongs extending therethrough. The thickness and width of the preferably flat bar prongs 429 is preferably such that the steaks can be suspended above the respective upper and lower grills.

In this way, cooking fluid flow is able to reach all exposed surfaces of the food product. Pairs of prongs are preferably spaced apart so as to be able to extend through most steak cuts. If slippage were to occur, the upper grill with its spacer bars would support the food product while still allowing large surface contact (as opposed to two steaks sliding into direct contact due to slippage. In an alternate embodiment the upper grill is not used, just the integrated lower grill and rack. For example, when deep-frying smaller poultry, such as a Cornish hen, one Cornish hen can be attached to each of prongs 429 of the lower grill 420 with the bottom of the hens preferably suspended (e.g., with the assistance of a prong protrusion) or provided resting on the grill 420. The rack assembly 431 is then lowered by the grasp device 216 into oil for deep-frying for an appropriate amount of time. When the Cornish hens are adequately fried, the rack assembly 431 is then removed from the oil via the lifting device 216. Thus, when deep-frying Cornish hens, it is not necessary to use the upper grill 440. Thus, the frying apparatus can take on the form of a double grill rack device with oil medium supporting pot or container having the same components only free of the upper grill or free of any grills as when the lower grill 420 is releasably attached. Various food positioning alternatives are also possible such as placing steak cuts or the like vertically oriented and cooking as a group or in combination with some alternate food(s) as in Cornish hens.

Thus, when deep-frying meats, such as steak or chops, one or more steaks, depending on size, can be skewered or attached to individual or groups of prongs 429 of the lower grill 20 below the curved bend 30 of the prong 429. The upper grill 440 is then set into place above the lower grill 420 and steaks and resting on the curved bends 430 of the prongs 429. More steaks can then be attached to the prongs 429 above the upper grill 440 preferably positioned so as to be suspended above the upper grill. The rack assembly 431 is then lowered into oil by the lifting extension in combination with the grasp hook 216 and grasping member 462 for deep-frying for an appropriate amount of time.

Also, in the embodiment illustrated in FIGS. 54-59 the movable components are represented by the rotatable handle 423 and the slidable upper grill 440 and all other components are permanently attached and generally fixed in position (e.g., welded together).

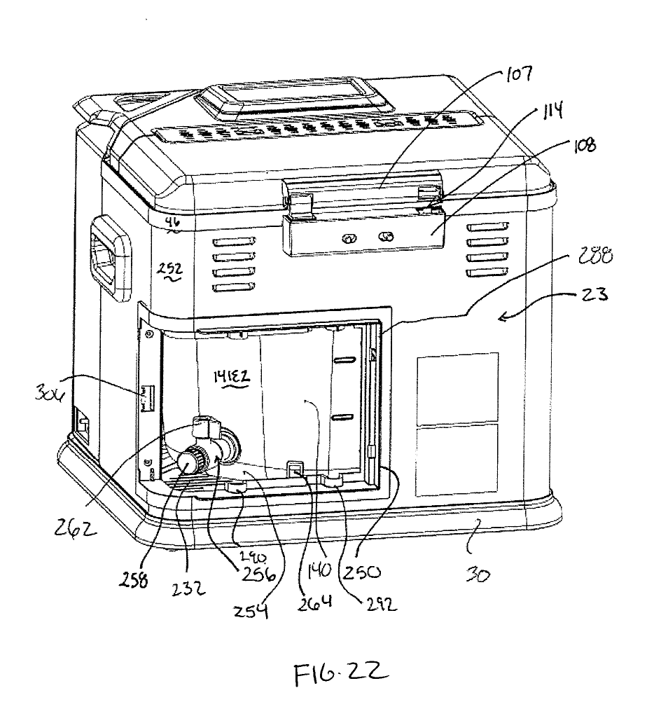

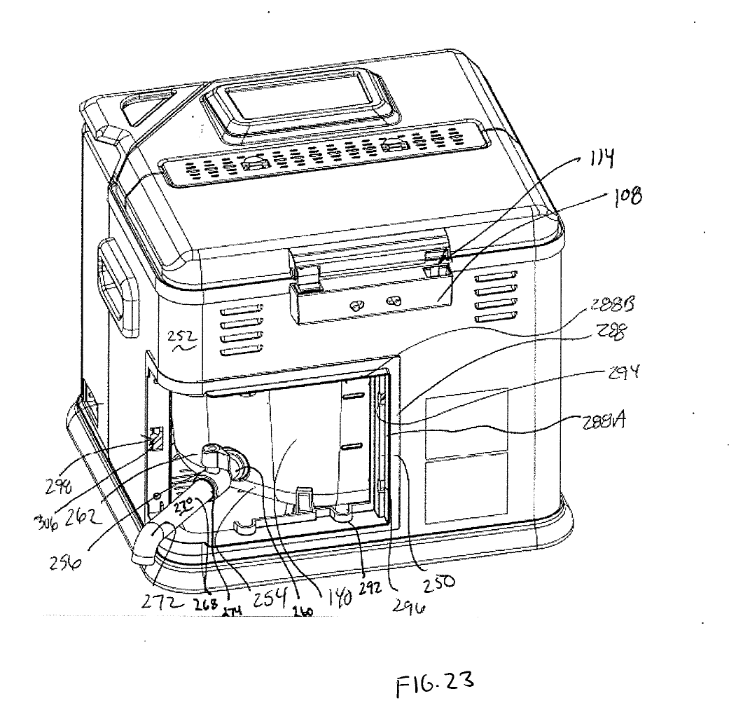

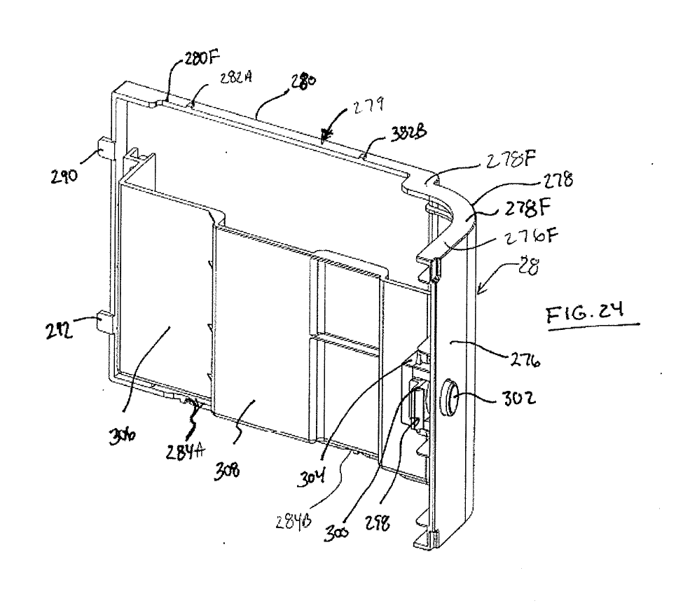

With reference to FIGS. 22 to 24 there is seen shell body 23 having a spigot access cavity 250 formed, in the illustrated embodiment, as to extend about a first corner region 252 of the main shell body 23. Further as seen from FIG. 22, at the base 254 of cooking pot 140 there is featured a spigot 256 in a first short or stub mode. Spigot 256 is shown as extending out in generally perpendicular fashion from cooking pot wall 141E2 (FIG. 16) and from a central region thereof. Thus a radially extending central axis extending out from the center of spigot 256 generally coincides with the maximum corner edge of corner region 252. Spigot 256 in the stub mode shown in FIG. 22 is further shown as having closure cap 258 closing off the spigot base 260 as well as a valve open/close handle 262. Further, the outer end of spigot 256 in the stub mode as represented by the cap 258 is preferably located inward of the interior of wall surface of the below described access cover 28 (FIG. 24) when in closed position. The spigot 256 in the stub mode is the typical setting for when it is desired to cook a turkey as the access cover 28 is closed preferably during cooking.

As further shown in FIG. 22, extending up off the upper surface of bottom panel 32 is a plurality (e.g., 3 or more) of cooking pot position retention brackets 264 (only one shown) which abut the base 254 of the cooking pot for a desired shell-to-cooking pot orientation (e.g., a proper positioning of the cooking pot and spigot section relative to the spigot access cavity 250). In a preferred embodiment the brackets 264 are strategically positioned as to allow only one position location for the cooking pot based on the relative relationship of bracket location and side wall configuration of the cooking pot (e.g., using the roof shaped cooking design's multi-shaped wall and bracket location choices to allow only one full recessed insertion position in cooking pot relative to the shell). Also, the brackets suspend the bottom of the cooking pot away from the interior surface of the underlying base 30.

Reference is made to FIGS. 7, 22, 46 and 51 to 53 for more detailed views of shell assembly base 30 as well as FIG. 29 for more detail as to the cooking pot and cooking pot position projections 264 relationship.

FIGS. 51 to 53 illustrate base 30 with flange base portion 34, bottom panel 32 and projection feet 33 and fastener protection cylinders 400 which house fasteners such as screws 402. From a comparison of FIGS. 7 and 51 it can be seen that fasteners 402 are aligned with projections 264A to 264D for securement of those fasteners to the upper surface of bottom panel 33. Projections 264A to 264D are shown mounted in a groove region 404 which is generally X-shaped with groove extension legs 404A to 404D extending out from a common central recess region 406. There is further provided an annular groove ring 408 in communication with the radial out ends of groove extension legs 40A to 40D which ring borders an upwardly extending interior wall portion of flange base portion 34.

In between adjacent pairs of groove legs 404 there is provided raised regions 405 having a polygonal configuration (e.g., generally triangular or trapezoidal) that further include air flow ports 408 that are thin, elongated slots that provide for air flow (e.g., bottom intake although exhaust flow direction also possible). These upwardly directed bumps with port slots 408 are raised further above the supporting surface which legs 33 contact (e.g., a countertop) than the underside of bottom panel 32 (which is also suspended off that supporting surface). In addition, air porting apertures 410 are provided in the corner reception recess 162 and air porting apertures 412 are provided in each of groove extensions 40A to 404D.

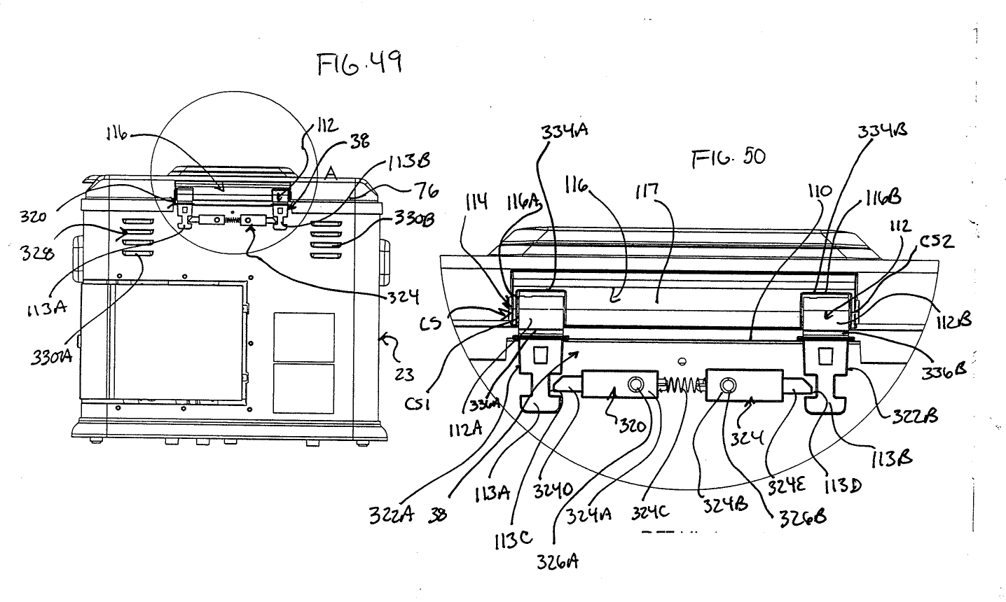

There can also be seen from FIG. 53 that projections 264A to 264D each have L-shaped general configuration with upper concave surfaces designed for snug nesting contact with the generally correspondingly curved exterior rim 338 of cooking pot 140. Further, the relative positioning of projections 264A to 264D is designed to assure proper positioning of the cooking pot (e.g., proper alignment of spigot 256 relative to access door 250 (FIG. 22) as well as the proper positioning of bump outs 342A to 342C for food holder reception. Thus, as can be seen from FIG. 29, projection 264A is designed for positioning contact with rim 338 at corner C1 which is the curved corner between pot walls 141A and 141B. Projection 264A is shown as being in general full resting contact on its exposed concave side (e.g., left and right curved ribs of that surface) as is the preferred relationship curved upper exposed for projections 264C to 264D.

Projection 264B is shown as having a similar corner positioning as 264A but at corner C2 between cooking pot wall 141B and 141C. The other two projections 264C and 264D are positioned for contact with the respective sloped wall surfaces 141E1 and 141E2 to opposite sides of corner peak wall 141P. The projections 264C and 264D are preferably positioned at an intermediate location along border 338 between peak corner 141P and respective corners C3 and C4 (see FIGS. 30 to 36) with a centered position being illustrative.

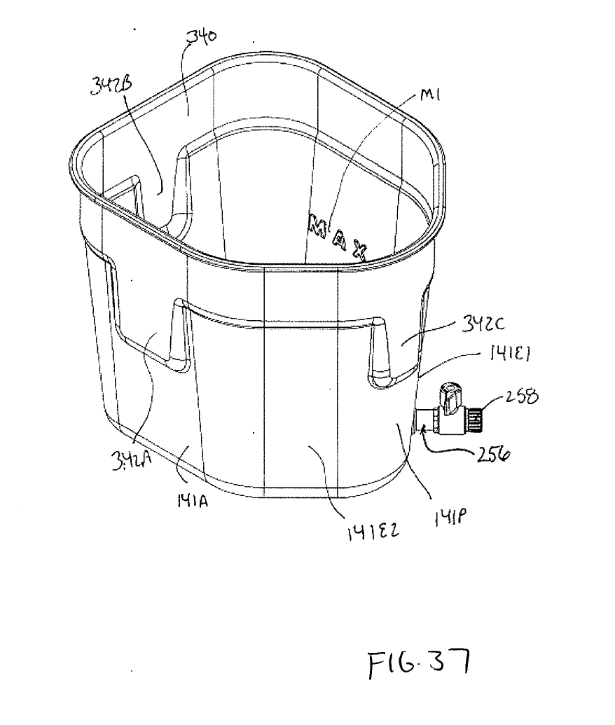

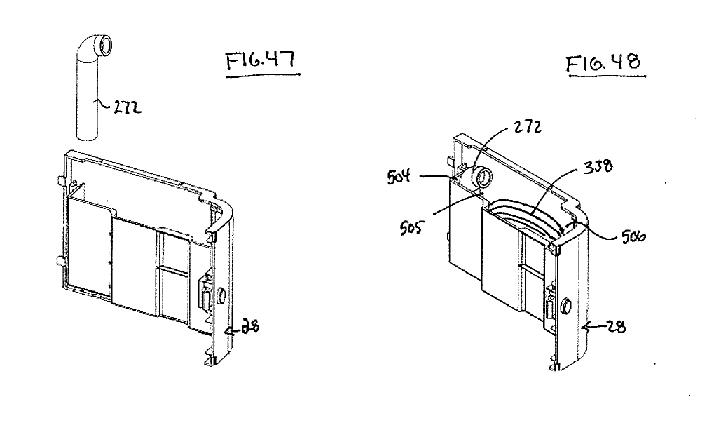

FIGS. 22 and 23 and FIGS. 37 and 38 as well as 46 there illustrated spigot 256 in its short and stub mode (FIGS. 22 and 37) and its lengthened or extension mode (FIGS. 23, 38 and 46). As seen from FIG. 22, closure cap 258 is provided to cap off the spigot while in its stub mode. The cap 258 is shown in FIG. 52 to be internal to the access door sill represented by shell aperture 250 which is closed off by access cover 28 (FIG. 24) when in closed position.

As noted earlier, spigot 256 has an extended mode as shown in FIG. 23 wherein extension conduit 272 is secured in place of cap 258 (e.g., a threading off of cap 258 and a threading on of extension 2721). In this embodiment the spigot is provided with an on/off flow valve as represented by valve 262 which is a finger twist flow block valve.

FIGS. 23 and 46 illustrate the bent outward end of extension conduit 272 positioned for a gravity flow drop to a suitable receptacle (direct or via an intermediate receptacle feed conduit (not shown)). Also, as seen in FIGS. 22 and 23 projection positioners 264 are designed to have the spigot outlet access extending through a corner of the shell main body that is covered over by shell access panel section 28 (which is shown as having a corner conforming curvature). Thus, as seen from FIG. 8, one side of shell assembly 22 has a first corner portion in which the spigot 256 extends while the opposite corner on that same side provides the corner base region in the base 30 that receives heater support structure 26. Further, the cooking pot with its “house” shape has its roof shaped portion positioned at that same side (24D) such that the tapered walls of the cooking pot 141E1 and 141E2 provide the clearance area external thereto to receive the spigot 256 and, at the opposite corner, the heating assembly 25 with triangular cross-section support tower 26.

On the opposite side wall 24B of shell section 26 there is a generally parallel relationship between the upper edge 140B of the cooking pot 140 (spaced inward by the radial perimeter ridge 44B width) and flange 44A. There is a similar generally parallel relationship between the shell sides 24A and 24C and corresponding upper edges 140A and 140C of the cooking pot and associated tapered walls. There is thus provided a flow channel that encompasses the side walls of the cooking pot within which a cooling flow of air can circulate such as air that enters through the various air flow slots in the bottom panel of base 30 which can then flow upward into the recess between the exterior of the cooking pot and interior of the shell walls. To further promote a natural convection flow about the cooking pot there is provided, in one embodiment, additional side wall venting means 330 as in the vent port sets 330A and 330B shown in FIG. 11 in shell side wall 24C at an upper region. As also shown in FIG. 11 access door 28 also extends across a significant portion of rear wall 24C as in more than 25% (e.g., 40 to 60% of overall length) in the illustrated embodiment.

FIGS. 24, 25, 28, 47 and 48 illustrate the storage compartment means of access door 28. As shown in FIG. 28 the cooking apparatus of the present invention, in one embodiment, features an electric power cord 338 which is preferably in the form of a plug in receptacle with a male/female release power connection assembly comprising a power prong featuring a recessed plug receptacle region 164 in control tower 26 having two male power connection projections that are received in female ports provided in the enlarged plug in base 338B of the power cord.

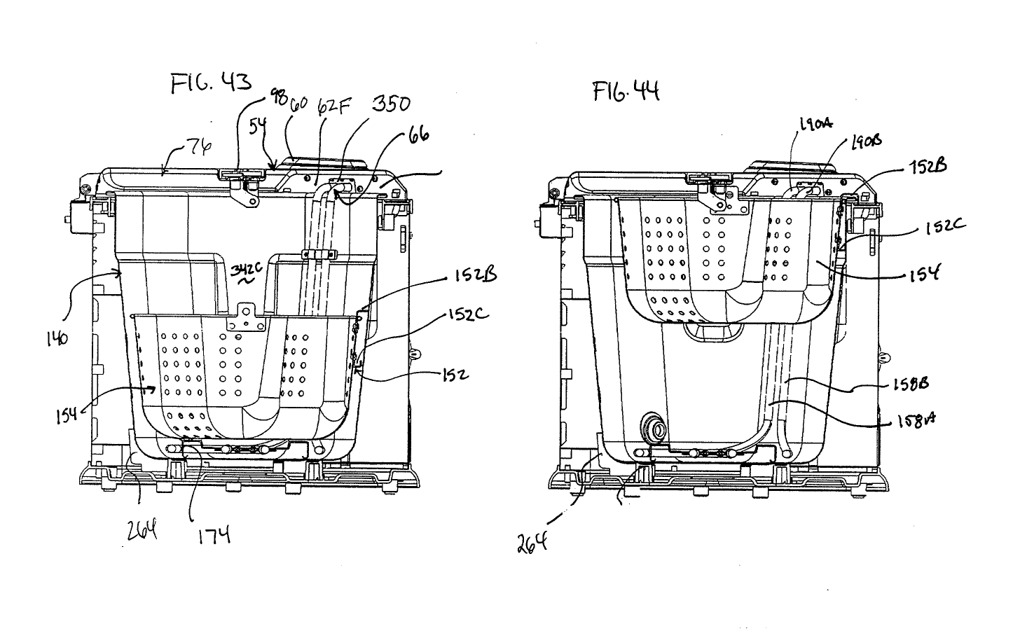

Further, as shown in FIG. 25 for example, access door 28 is provided with a first (e.g., smaller) compartment 504 and a second (e.g., larger) compartment 506 which are separated by flange 505 and are designed to receive unconnected components of an embodiment of the cooking apparatus such as extension conduit 268 being received (e.g., in a vertical orientation fashion) in first compartment 504 and power cord 338 received in the second, larger conduit 506 as shown in FIG. 48.

With reference to FIG. 23 there is illustrated spigot 256 in an extended mode wherein spigot 256 has in place of the cap 258 a spigot nozzle extension 268 shown as having an elongated nozzle body section 270 which extends into a downwardly curved nozzle outlet 272. As with the cap there is preferably provided a hand grip ring 274 for threaded attachment to a threaded end of the spigot stub base 260. In the illustrated embodiment stub base 260 extends through an aperture provided in the cooking pot wherein suitable threaded seal rings are provided to seal off the area.

Thus, an operator can readily switch the modes of spigot 256 between the stub mode useful for cooking with the access door closed to a drain mode featuring the nozzle extension's outlet 272 spaced externally to the outer shell body wall surfacing as to provide for gravity drainage to a below positioned suitable cooking fluid receptacle as in after sufficient cooling of the same. When drainage is completed, the nozzle 272 can be detached and replaced with the cap 258 (preferably also after cleaning of the respective surfaces).

With reference to FIG. 24 there is seen an embodiment of access cover 28 which comprises a first planar wall section 276, an intermediate curved wall section 278 and a second, longer planar wall section 280. The combination wall 279 made up of wall sections 276, 278 and 280 thus provides for corner extension coverage as to the access aperture 250 formed in shell body 23 such that the corresponding exterior wall surfaces of the shell body 23 and the exterior wall surfaces of sections 276, 278 and 280 generally are coplanar (e.g., the combination wall 279 and the surrounding wall surface of shell body 23 provide an overall smooth exterior wall surface in that region of the shell's corner).

Access cover 28 preferably also features an upper and a lower flange extension with the upper flange identified by flange sections 276F, 278F and 280F, with a similar set up for the lower flange. The flanges extend perpendicularly off from respective upper and lower edges of the sections 276 to 280. As seen, the flange extensions extend for essentially the full overall length of combination wall 279. There is further featured strategically positioned retention projections 282A and 382B as well as respective female alignment recess as in 284A and 284B. That is, the edging 288 of the shell body 23 defining access cavity 250 is provided with the aforementioned projections in the illustrated embodiments although a reverse male/female projection—cavity relationship is also featured under the invention.

Access edging 288 (FIG. 23) includes general border edging 288A as well as an outwardly extending flange 288B shown as having a rotated U-shaped configuration and curved ends to go down from the outer extension of the free edge of edging 288B to the border edging 288A. Thus, when the access door is in a closed state there is provided a degree of overlap relative to the flanges 282 and 284 of the access door and the U-shaped edging 288B. Also at the free end of the elongated section 280 there is provided a pair of placement retention projections 290 and 292 designed for reception in corresponding reception cavities 284A and 284B in the border edge region for access aperture 250. There is still further featured just inward of the free end region of wall section 276 a capture lock assembly 298 comprising a catch member 300 and an adjustment drive member 302.

Catch member 300 is shown in FIG. 24 as including a hook shaped extension member (as in a plastic deflection hook shaped member) having a base supported on an internal side of access door or cover by support 304. Catch member 300 is designed to flex into a catch engagement when received within catch recess 306 formed in an interior wall of shell body 23 and deflect out of engagement upon a pressing of the drive member 302 shown as a button extending out away from the exterior surface of the access cover 266 for finger pressing. There is further featured interior extension member 306 on an interior side having a stepped wall configuration inclusive of the most interior wall panel 308 which is designed as to extend inward toward the cooking pot.

While the invention has been described in terms of various preferred embodiments and methods for performing the procedure, those skilled in the art will recognize that various changes and modifications may be made without departing from the spirit and scope of the invention, as defined in the appended claims.

What is claimed is:

1. A cooking apparatus, comprising:
a shell assembly comprising a cover assembly and a shell body defining a reception cavity;
a cooking pot received within the reception cavity;
a heating device positioned as to heat a fluid in said cooking pot when in use;
a cover supported by said shell body, said cover being adjustable between a cooking pot cover position and a cooking pot access position, and said cover having first and second cover parts that are adjustable relative to each other as to go from an extended cover position to a less extended cooking pot access position.

2. The cooking apparatus of claim 1 wherein said cover includes a first connector and said first and second cover parts are connected by said first connector such that a first surface of said first part and a first surface of said second part mutually adjust from a more common plane orientation when in the cooking pot cover position to a less common plane orientation when in the cooking pot access position.

3. The cooking apparatus of claim 2 further comprising a second connector and wherein said second cover part is adjustably connected by said second connector to said shell body, and wherein each of said first and second connectors are hinge connectors.

4. The cooking apparatus of claim 2 wherein said first connector is a pivot connector and wherein one of said first and second cover parts includes a male projection flange in a region of said first connector and the other of said first and second cover parts includes a recessed region for receiving said male projection flange, and wherein at least one of said recessed region and said male projection flange have one or more venting ports.

5. The cooking apparatus of claim 4 wherein each of said recessed region and said projection flange have one or more venting ports which are arranged for vapor passage from the cooking pot, though the cover and to the environment.

6. The cooking apparatus of claim 1 wherein said first and second cover parts each have an extended surface facing and wherein said extended surface facings are arranged essentially along a common plane extending over the cooking pot when in the extended cover position and wherein said extended surfaces are in a relative juxtaposed contacting or relative juxtaposed acute angle orientation when in the less extended cooking pot access position, and wherein said cover comprises a second connector and said first cover part has a free edge opposite an end connected with said first connector and said second cover part has a first end connected with said first connector and a second end pivotably connected with said second connector to the shell body, and wherein each of said extended surfaces of said first and second parts face said cooking pot when in said extended cover position and face each other when in the less extended cooking pot access position.

7. The cooking apparatus of claim 1 wherein said cooking pot is dimensioned to receive a whole turkey of 12 pounds or more, and said cooking pot having a house shaped cross-section and tapering walls.

8. The cooking apparatus of claim 1 wherein said cooking pot is dimensioned to receive a whole turkey of 12 to 16 pounds together with sufficient cooking fluid of 2 gallons or less, with the cooking pot configuration providing for substantial coverage of the whole turkey with the 2 gallons or less of cooking fluid, with substantial coverage providing a cooking fluid level within ½ inch under, at or over the received whole turkey.

9. The cooking apparatus of claim 1 wherein said cover includes a window which is dimensioned as to be in only one of said first and second cover parts, and wherein said cover includes a window which has a sloping exposed viewing surface.

10. The cooking apparatus of claim 1 further comprising a plug in heating device support structure and wherein said shell body includes a recessed section in which said heating device support structure is received, and said cover including a cantilever section extending over a portion of said heating device support structure and forming a hand grasp location for lifting said cover.

11. The cooking apparatus of claim 1 further comprising a heating unit support tower which includes a power connection port and wherein said shell includes a recessed section receiving said heating unit support tower and said support tower occupying a recessed region of said shell main body and being dimensioned to provide a generally uninterrupted polygonal exterior side wall surface in said shall assembly.

12. The cooking apparatus of claim 1 wherein said heating device is supported in a removable heating device support structure that fills in a recessed corner section of said shell body and said heating device includes a heating element which extends along a said wall of the shell body and over an upper edge of the cooking pot and down into said cooking pot as to be in direct fluid contact with cooking fluid when placed in the cooking pot.

13. The cooking apparatus as recited in claim 1 wherein, when in said less extended cooking pot access position, said first and second cover parts have axes of elongation that are more vertically oriented than horizontally oriented, and wherein said cover includes a first connector and said first and second cover parts are connected by said first connector and said cooking apparatus further comprising a second connector connecting one of said first and second cover parts to said shell body and wherein said second connector includes a stop which provides for a fixed in position over-the-center vertical orientation in the collapsed cover.

14. The cooking pot apparatus of claim 1 wherein said shell body comprises a spigot access aperture and a spigot access aperture closure member which is adjustable between a spigot access aperture closure state and spigot access state, and wherein at least one of said shell body and said spigot access closure member includes a bias open member and a close capture member, and wherein said shell body has a generally rectangular configuration, and said cooking apparatus further comprising a heating unit support tower and wherein said shell body includes a first corner section which includes a recess for receiving said heating unit support tower.

15. The cooking apparatus of claim 1 further comprising a food holder and wherein said shell assembly comprises an upper peripheral rim which is supported by a wall of said shell body and includes one or more surface indentations which indentations include
a) a catch indentation which is positioned for receipt of a catch portion of a food holder, or
b) a condensation capture recess, or
c) both a) and b).

16. The cooking apparatus of claim 15 wherein said shell assembly includes a catch indentation, and said food holder is a basket which includes a depressed region for receipt of the heater device which depressed region is positioned as to be in better alignment relative to said heater device when said basket is in a catch relationship relative to said catch indentation than when in a cooking position in said cooking pot.

17. A cooking apparatus comprising:
a shell assembly with a shell body, a base and a reception cavity;
a cooking pot removably received within the reception cavity of said shell body;
a heater device which is positioned as to heat cooking fluid received in the cooking pot when the cooking apparatus is in use;
a cover assembly supported by said shell assembly as to extend over the cooking pot during cooking; and
a heater support structure which supports said heater device, and said heater support structure being configured to fill in a recessed exterior wall region formed in said shell body.

18. The cooking apparatus of claim 17 wherein said heater support structure comprises a heating unit support tower having a configuration that fills in the recessed exterior wall region of said shell body as to fill in a missing corner region of a multi-side wall cooking apparatus.

19. The cooking apparatus of claim 18 wherein said support tower and said base are configured and arranged as to form a male projection/female recess releasable connection therebetween.

20. The cooking apparatus as recited in claim 18 wherein said shell assembly comprises a spigot cover access door at another corner area of said shell body.

21. The cooking apparatus of clam 20 wherein said cooking pot has a house shaped cross-section with a pair of sloping roof walls which define a peak projection which sits between a first corner occupied by said heater support structure and a second corner occupied by said access cover.

22. The cooking apparatus of claim 17 wherein said cooking pot has a generally house shaped profile and tapering side walls which tapering walls define a 2 gallon or less cooking fluid volume for cooking a whole turkey of 12 pounds or greater.

23. A method of cooking a 12 pound or larger whole turkey, comprising:
inserting the turkey within a cooking pot retained within a shell body;
covering over the turkey and cooking pot with a cover device, wherein said cover device includes a first cover part, a second cover part, a first connector pivotably connecting said first and second parts together and a second connector pivotably connecting said second cover part to said shell body;
lifting said cover device such that said first and second cover parts rotate toward one another and such that said first and second cover parts are moved from an extended cover position to a collapsed cooking pot access position.

24. The method of claim 23 wherein inserting the turkey into the cooking pot includes inserting a turkey into a food support basket which is received by said cooking pot with each of said basket and cooking pots having a generally house shaped profile.

25. A cooking apparatus, comprising:
a shell assembly with a reception cavity and a shell body;
a cooking pot received within the reception cavity;
a heating device positioned as to heat a fluid in said cooking pot when in use;
said shell assembly further including a cover supported by said shell body,
and wherein said shell assembly, which is polygonal configured, comprises a spigot access door which extends about a first corner region of said polygonal configured shell assembly and said shell assembly further comprising a releasable heating device support structure positioned at another corner region of said polygonal configured shell assembly.

26. The cooking apparatus of claim 25 wherein said shell assembly comprises a base structure above which said shell body extends and said heating device support structure has a male/female releasable connection arrangement with that base structure and is configured as to occupy a corner region of said shell assembly.

27. A cooking apparatus comprising:
a shell assembly having a cover and a shell main body defining a recess;
a cooking pot received within the recess;
said cooking pot having a house shaped cross-section with a foundation wall, first and second side walls extending from respective ends of said foundation wall and a roof shaped wall combination bridging said side walls, and said foundation wall, first and second side walls and said roof shaped wall combination having a taper that includes a convergence section in going from an upper edge to a bottom of said cooking pot, wherein the taper is of an angle and the house shaped cross section in said pot provides for sufficient liquid cooking fluid contact relative to a whole turkey of 12 pounds or more with about 2 gallons or less in liquid cooking fluid.
